(19) United States
(12) Patent Application Publication
(10) Pub. No.: US 2008/0002560 A1
(43) Pub. Date: Jan. 3, 2008

(54) WRITE ONCE INFORMATION RECORDING MEDIUM AND DISK APPARATUS

(76) Inventors: Seiji Morita, Yokohama-shi (JP); Koji Takazawa, Tokyo (JP); Kazuyo Umezawa, Yokohama-shi (JP); Naoki Morishita, Yokohama-shi (JP); Naomasa Nakamura, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/767,675

(22) Filed: Jun. 25, 2007

(30) Foreign Application Priority Data
Jun. 30, 2006 (JP) 2006-182806

(51) Int. Cl. G11B 7/24

(52) U.S. Cl. 369/275.4

(57) ABSTRACT

According to one embodiment, a first recording film, interlayer, and second recording film are formed on a transparent resin substrate having a groove and land. A recording mark is formed by irradiation with a short-wavelength laser beam. The light reflectance of the recording mark formed by irradiation with the short-wavelength laser beam is higher than a light reflectance before irradiation with the short-wavelength laser beam. The first recording film has a first read-only recording mark recorded by a three-dimensional pit. The second recording film has a second read-only recording mark recorded by a three-dimensional pit. The reflectances of the pits of the first and second recording layers are 4.2% to 8.4%, or the pit width of the second recording film is larger than that of the first recording layer.

### CROSS-REFERENCE TO RELATED APPLICATIONS

This application is based upon and claims the benefit of priority from Japanese Patent Application No. 2006-182806, filed Jun. 30, 2006, the entire contents of which are incorporated herein by reference.

### BACKGROUND

1. Field

One embodiment of the present invention relates to a write once information recording medium capable of recording/playback of information by using a short-wavelength laser beam such as a blue laser beam, and a display apparatus for playing back the medium.

2. Description of the Related Art

As is well known, the recent spread of personal computers and the like is increasing the importance of digital data storage media. For example, information recording media capable of digital recording/playback of long-time video information and audio information are presently widespread. Also, information recording media for digital recording/playback are beginning to be used in mobile apparatuses such as cell phones.

Many information recording media of this type have disk shapes because disks have a large information recording capacity and a high random accessibility which allows rapid retrieval of desired recorded information. In addition, disks can be easily stored and carried because they are compact and light in weight and also inexpensive.

Presently, so-called optical disks capable of recording and playing back information in a non-contact state by irradiation with a laser beam are most frequently used as disk-like information recording media. These optical disks mainly comply with the CD (Compact Disk) standards or DVD (Digital Versatile Disk) standards, and these two standards have compatibility.

The optical disks are classified into three types: read-only optical disks incapable of information recording such as a CD-DA (Digital Audio), CD-ROM (Read-Only Memory), DVD-V (Video), and DVD-ROM; write once optical disks capable of writing information once such as a CD-R (Recordable) and DVD-R; and rewritable optical disks capable of rewriting information any number of times such as a CD-RW (ReWritable) and DVD-RW.

Of the optical disks capable of recording, the write once optical disks using organic dyes in recording layers are most popular because the manufacturing cost is low. This is so because users rarely rewrite recorded information with new information when using optical disks having information recording capacities exceeding 700 MB (Mega Bytes), so it is only necessary to record information just once.

In a write once optical disk using an organic dye in a recording layer, a recording region (track) defined by a groove is irradiated with a laser beam to heat a resin substrate to its glass transition point Tg or more, thereby causing a photochemical reaction of an organic dye film in the groove and producing a negative pressure. Consequently, the resin substrate deforms in the groove to form a recording mark.

A representative example of an organic dye used in a CD-R for which the wavelength of a recoding/playback laser beam is about 780 nm is a phthalocyanine-based dye such as IGRAPHOR Ultragreen MX manufactured by Ciba Specialty Chemicals. A representative example of an organic dye used in a DVD-R for which the wavelength of a recoding/playback laser beam is about 650 nm is an azo metal complex-based dye manufactured by MITSUBISHI KAGAKU MEDIA.

For the next-generation optical disks which achieve high-density, high-performance recording/playback compared to the present optical disks, a blue laser beam having a wavelength of about 405 nm is used as a recording/playback laser beam. Unfortunately, no organic dye material capable of obtaining practically satisfactory recording/playback characteristics by using this short-wavelength light has been developed yet.

That is, the present optical disks which perform recording/playback by using an infrared laser beam or red laser beam use organic dye materials having absorption peaks at wavelengths shorter than the wavelengths (780 and 650 nm) of the recording/playback laser beams. Accordingly, the present optical disks realize so-called H(High)-to-L(Low) characteristics by which the light reflectance of a recording mark formed by irradiation with a laser beam is lower than a light reflectance before the laser beam irradiation.

By contrast, when performing recording/playback by using a blue laser beam, an organic dye material having an absorption peak at a wavelength shorter than the wavelength (405 nm) of the recording/playback laser beam is inferior not only in stability to ultraviolet radiation or the like and storage durability but also in stability to heat. This lowers the contrast and resolution of a recording mark.

Also, the blur of a recording mark often enlarges to have an effect on adjacent tracks and easily deteriorates the crosswrite characteristic. In addition, the recording sensitivity lowers, and this makes it impossible to obtain a high playback signal S/N (Signal-to-Noise) ratio and low bit error rate.

Note that when no information is recorded on adjacent tracks, a practical recording sensitivity is sometimes obtained. If information is recorded on adjacent tracks, however, crosswrite to the adjacent tracks increases, and this decreases the playback signal S/N ratio and increases the bit error rate, so no practically suitable level is achieved.

Recently, as disclosed in Jpn. Pat. Appln. KOKAI Publication No. 2000-322770, a double-layer DVD-R is proposed for the demand for increasing the capacity of the write once recording disk. The double-layer DVD-R is a disk given a large capacity of 8.5 GB by forming two recording layers in the DVD-R, and has two organic dye recording films.

The disk configuration has a forward stacked structure or reverse stacked structure. When using organic dye layers as recording films in the reverse stacked structure, first and second layers are formed on different substrates and adhered by an adhesive such that the two substrates are outside. The first layer is formed by sequentially stacking the substrate, the organic dye layer, and a reflecting film, and the second layer is formed by sequentially stacking the substrate, a reflecting film, and the organic dye layer. Therefore, the organic dye layers and reflecting films are stacked in reverse order. Since, however, interference occurs between the organic dye layer as the second layer and the adhesive, a barrier layer (protective layer) made of a dielectric material is formed on the organic dye layer as the second layer, and the adhesive is applied via this barrier layer. The formation of the barrier layer requires an additional manufacturing facility and hence increases the cost, and often lowers the cycle time of mass-production. It is also difficult to obtain good recording/playback characteristics as disk performance.

Accordingly, the forward stacked structure is presumably more suitable. However, the manufacturing process is very complicated, and a cycloolefin polymer (COP) substrate must be used as a transfer stamper of the second layer. These factors increase the cost and decrease the yield. This manufacturing method is limited to a double-layer DVD-R which performs recording/playback by a red laser, and is inapplicable to the manufacturing process of a double-layer HD DVD-R having a higher density.

In this double-layer HD DVD-R, it is difficult to ensure a sufficient quality of a playback signal in a read-only region in which management information is recorded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view showing the sectional structure of an example of a write once information recording medium according to an embodiment of the present invention;

FIG. 2 is a schematic view showing the procedure of a method of manufacturing the example of the write once information recording medium according to an embodiment of the present invention;

FIG. 3 is a view for explaining a normalized wobble amplitude NWS used to evaluate the write once information recording medium;

FIG. 4 is a view showing the characteristics of organic dye materials usable in an embodiment of the present invention;

FIGS. 5A to 5C are graphs showing the relationship between the laser beam wavelength and absorbance for each dye;

FIGS. 6A and 6B are graphs showing the relationship between the laser beam wavelength and absorbance for each dye;

FIGS. 7A. 7B, 7C, 7D, 7E, 7F, and 7G are graphs for explaining the change in absorbance with the wavelength of a laser beam for seven examples of other organic dye materials to be contained in a recording film;

FIG. 8 is a waveform diagram showing an example of a signal to be recorded on the write once information recording medium in order to conduct evaluation tests for recording/playback evaluation;

FIG. 9 is a view for explaining the measurement results obtained by conducting the evaluation tests on the example of the write once information recording medium according to an embodiment of the present invention;

FIG. 10 is a view for explaining the measurement results obtained by conducting playback durability tests on the example of the write once information recording medium according to an embodiment of the present invention;

FIGS. 11A and 11B are views for explaining the configuration of wobble address data of the example of the write once information recording medium according to an embodiment of the present invention;

FIGS. 12A to 12E are views for explaining the types of wobble data units WDU of the example of the write once information recording medium according to an embodiment of the present invention;

FIGS. 13A and 13B are views for explaining the configuration of the wobble address data of the example of the write once information recording medium according to an embodiment of the present invention;

FIG. 14 is a view for explaining the type of wobble of the example of the write once information recording medium according to an embodiment of the present invention;

FIGS. 15A, 15B, 15C, and 15D are views for explaining the physical segment configuration of the wobble address data of the write once information recording medium;

FIGS. 16A, 16B, and 16C are graphs for explaining the SbER, wobble CNR, and carrier level fluctuation as a function of the wobble amplitude of the write once information recording medium;

FIG. 17 is a graph for explaining NWS as a function of the wobble amplitude of the write once information recording medium;

FIG. 18 is a view for explaining the relationship between a groove and land in the example of the write once information recording medium according to an embodiment of the present invention;

FIGS. 19A and 19B are views for explaining the wobble of groove tracks in the example of the write once information recording medium according to the an embodiment of present invention;

FIG. 20 is a block diagram showing an outline of the arrangement of a disk apparatus for playing back the example of the write once information recording medium according to an embodiment of the present invention;

FIG. 21 is a view for explaining recording marks formed in the recording film of the example of the write once information recording medium according to an embodiment of the present invention; and

FIG. 22 is a view for explaining the data structure of the example of the write once information recording medium according to an embodiment of the present invention.

### DETAILED DESCRIPTION

Various embodiments according to the invention will be described hereinafter with reference to the accompanying drawings. In general, according to one embodiment of the invention, a first recording film, interlayer, and second recording film are formed on a transparent resin substrate having a groove and land. A recording mark is formed by irradiation with a short-wavelength laser beam. The light reflectance of the recording mark formed by irradiation with the short-wavelength laser beam is higher than a light reflectance before irradiation with the short-wavelength laser beam. The first recording film has a first read-only recording mark recorded by a three-dimensional pit. The second recording film has a second read-only recording mark recorded by a three-dimensional pit. The reflectances of the pits of the first and second recording layers are 4.2% to 8.4%, or the pit width of the second recording film is larger than that of the first recording layer.

The present invention is roughly classified into the first to fourth aspects.

Inventions according to the first and second aspects are write once information recording media basically comprising a transparent resin substrate having a groove and land with one of a concentric shape and a spiral shape, a first recording film formed on the groove and land of the transparent resin substrate, an interlayer made of a transparent resin material having a groove and land with the above shape, and a second recording film formed on the groove and land of the interlayer. In these write once information recording media, a recording mark is formed by irradiation with a short-wavelength laser beam, and the light reflectance of the recording mark formed by irradiation with the short-wavelength laser beam is higher than a light reflectance before irradiation with the short-wavelength laser beam. In addition, the groove wobbles within a predetermined amplitude range, and the first and second recording films respectively have first and second read-only recording marks recorded by three-dimensional pits.

The present invention provides double-layer write once information recording media capable of recording and playing back high-density information on a highly practical level.

The write once information recording media according to the first and second aspects further have the following characteristics in respect of the pit reflectances or pit widths of the first and second read-only recording marks.

In the write once information recording medium according to the first aspect, the reflectances of the pits of the first and second read-only recording marks are 4.2% to 8.4%.

In the write once information recording medium according to the second aspect, the pit width of the second read-only recording mark is larger than that of the first read-only recording mark.

Inventions according to the third and fourth aspects are disk apparatuses for playing back write once information recording media. The invention according to the third aspect is a disk apparatus for playing back the write once information recording medium according to the first aspect. The invention according to the fourth aspect is a disk apparatus for playing back the write once information recording medium according to the second aspect.

Embodiment of the present invention will be explained in more detail below with reference to the accompanying drawing.

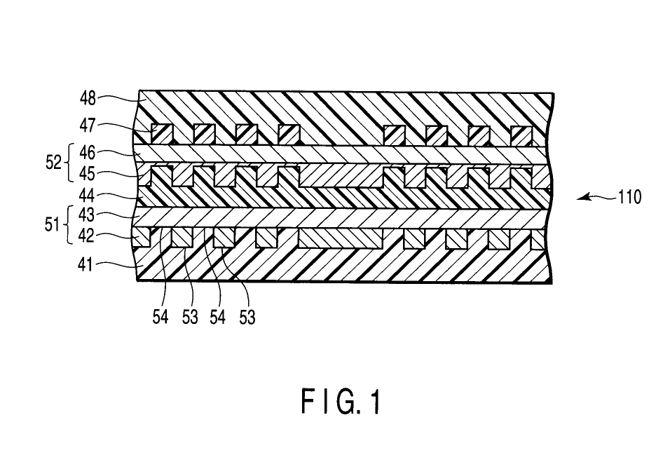

FIG. 1 is a schematic view showing the sectional structure of an example of a write once information recording medium according to an embodiment of the present invention.

As shown in FIG. 1, a double-layer write once information recording medium 110 comprises, on a first substrate 41 made of a transparent resin and having concentric or spiral grooves and lands, a first recording film 51 formed on grooves 53 and lands 54 of the first substrate 41, an interlayer 44 made of a transparent resin material such as an ultraviolet-curing resin and having concentric or spiral grooves 53 and lands 54, and a second recording film 52 formed on the grooves 53 and lands 54 of the interlayer 44.

The first recording film 51 comprises a first organic dye layer 42 formed on the grooves 53 and lands 54 of the transparent resin substrate 41, and a semitransparent layer 43 formed on the first organic dye layer 42 and made of, e.g., a silver alloy. The second recording film 52 comprises a second organic dye layer 45 formed on the interlayer 44, and a reflecting layer 46 made of, e.g., a silver alloy.

Also, a second substrate 48 made of a transparent resin or the like is formed on the silver alloy reflecting layer 46 via an adhesive layer 47.

A method of manufacturing the double-layer write once information recording medium of an embodiment of the present invention will be described below.

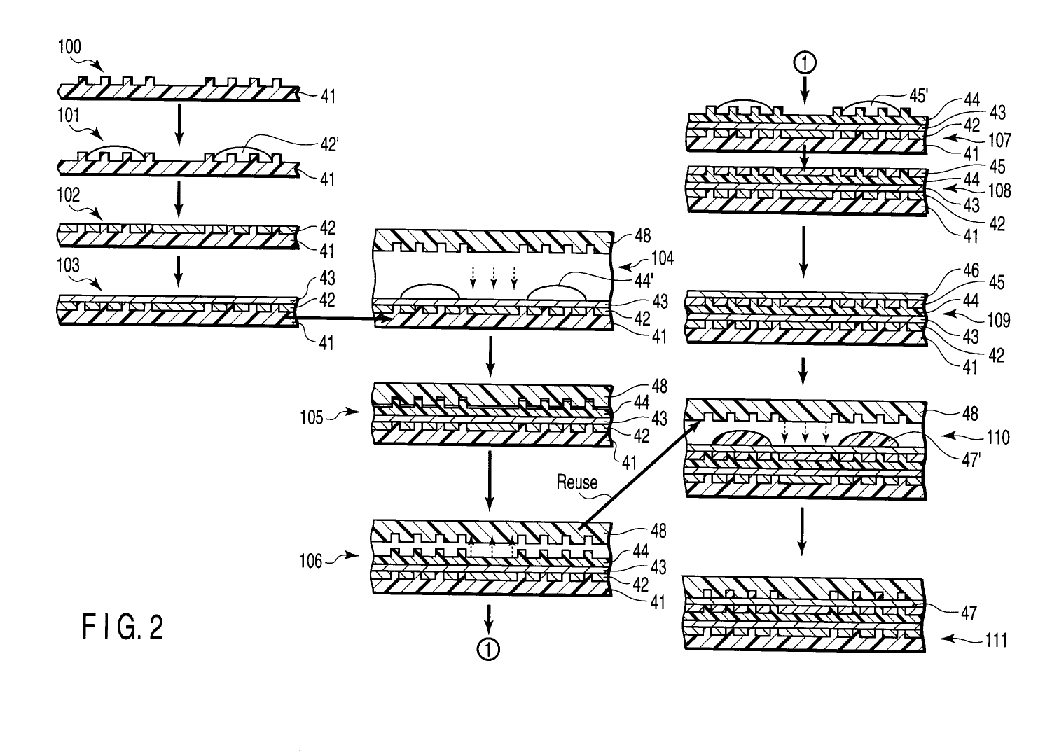

FIG. 2 is a schematic view showing the procedure of the method of manufacturing the example of the write once information recording medium described above.

Reference numerals 100 to 111 in FIG. 2 denote models for explaining steps of manufacturing the example of the write once information recording medium.

First, a step denoted by 100 prepares an L0 polycarbonate substrate 41 obtained by injection molding of an L0 Ni stamper obtained in a mastering step, in order to form a first recording film (L0) 51. An L0 organic dye material 42′ is applied on the substrate 41 as indicated by 101, and spin-coated and dried as indicated by 102, thereby obtaining a first organic dye layer 42.

Then, a step denoted by 103 forms a semitransparent layer 43 by sputtering, e.g., a silver alloy, thereby obtaining a stacked structure of the first organic dye layer 42 and semitransparent layer 43, as a first recording film (L0) 51, on the substrate 41.

Meanwhile, a second recording film (L1) Ni stamper (mother stamper) obtained in a mastering step is injection-molded to prepare an L1 polycarbonate substrate 48.

An ultraviolet-curing resin 44′ is applied as indicated by 104 on the semitransparent layer 43 of the stacked structure obtained in the step denoted by 103, thereby forming an ultraviolet-curing resin layer 44 by spin coating.

Subsequently, as indicated by 105, the L1 polycarbonate substrate 48 is pressed against the ultraviolet-curing resin 44 and temporarily adhered by ultraviolet radiation. Note that the spin conditions are adjusted to make the thickness of the ultraviolet-curing resin 44′ uniform.

After that, as indicated by 106, the L1 polycarbonate substrate 48 is removed from the cured ultraviolet-curing resin 44.

Then, an L1 organic dye material 45′ is applied, spin-coated, and dried on the surface of the ultraviolet-curing resin layer 44 as indicated by 107, thereby forming a second organic dye layer 45 as indicated by 108.

Furthermore, a reflecting layer 46 is formed by sputtering, e.g., a silver alloy as indicated by 109, thereby obtaining a second recording film (L1) having a stacked structure of the second organic dye layer 45 and reflecting layer 46.

After that, an adhesive 47′ is applied on the reflecting layer 46 as indicated by 110. In addition, the step denoted by 106 reuses the polycarbonate substrate 48 removed as the L1 transfer stamper and adheres it via an adhesive layer 47, thereby obtaining a double-layer write once information recording medium having the arrangement denoted by 110.

The present invention can use, as the ultraviolet-curing resin, a material which can be easily removed from the polycarbonate substrate and stuck to the Ag layer or Ag alloy layer. The use of this ultraviolet-curing resin facilitates transfer of the land-groove pattern of L1 to the ultraviolet-curing resin layer 44.

It is only necessary to use one type of ultraviolet-curing resin as described above, and L1 can be formed by the spin adhesion method without using any conventional vacuum bonding step. This simplifies the bonding step and the facility for the step.

In addition, this ultraviolet-curing resin is readily removable from the polycarbonate substrate, so the substrate hardly warps. Consequently, a favorable write once information recording medium having a push-pull signal modulation degree of 0.26 or more is obtained.

The push-pull signal modulation degree is preferably as large as possible. Also, the warpage (tilt angle) is preferably as small as possible.

The ultraviolet-curing resin usable in an embodiment of the present invention is a polymer material containing, e.g., carbon, hydrogen, nitrogen, and oxygen as main components. The oxygen ratio in this polymer material can be 11 atm % or more.

The ultraviolet-curing resin containing carbon, hydrogen, nitrogen, and oxygen as main components and having an oxygen ratio of 11 atm % or more can be easily removed from the polycarbonate substrate and stuck to the Ag layer or Ag alloy layer. According to another embodiment, the oxygen ratio can be 11 to 14 atm %.

The “main component” herein mentioned is an element having a relatively high atomic ratio among elements forming a polymer material, e.g., an element having either the highest atomic ratio or an atomic ratio close to the highest atomic ratio.

The ultraviolet-curing resin material used in the present invention is formed by mixing a monomer, oligomer, adhesive, and polymerization initiator. It is also possible to mix a plurality of types of monomers and a plurality of types of oligomer materials.

The following materials are used as the monomer material.

Acrylates
Bisphenol A.ethylene oxide modified diacrylate (BPEDA)
Dipentaerythritol hexa(penta)acrylate (DPEHA)
Dipentaerythritolmonohydroxy pentaacrylate (DPEHPA)
Dipropyleneglycol diacrylate (DPGDA)
Ethoxylated trimethylolpropane triacrylate (ETMPTA)
Glycerinpropoxy triacrylate (GPTA)
4-hydroxybutyl acrylate (HBA)
1,6-hexanediol diacrylate (HDDA)
2-hydroxyethyl acrylate (HEA)
2-hydroxypropyl acrylate (HPA)
Isobornyl acrylate (IBOA)
Polyethyleneglycol diacrylate (PEDA)
Pentaerythritol triacrylate (PETA)
Tetrahydrofulfuryl acrylate (THFA)
Trimethylolpropane triacrylate (TMPTA)
Tripropyleneglycol diacrylate (TPGDA)

Methacrylates
Tetraethyleneglycol dimethacrylate (TEDMA)
Alkyl methacrylate (AKMA)
Allyl methacrylate (AMA)
1,3-butyleneglycol dimethacrylate (BDMA)
n-butyl methacrylate (BMA)
Benzyl methacrylate (BZMA)
Cyclohexyl methacrylate (CHMA)
Diethyleneglycol dimethacrylate (DEGDMA)
2-ethylhexyl methacrylate (EHMA)
Glycidyl methacrylate (GMA)
1,6-hexanediol dimethacrylate (HDDMA)
2-hydroxyethyl methacrylate (2-HEMA)
Isobornyl methacrylate (IBMA)
Lauryl methacrylate (LMA)
Phenoxyethyl methacrylate (PEMA)
t-butyl methacrylate (TBMA)
Tetrahydrofurfuryl methacrylate (THFMA)
Trimethylolpropane trimethacrylate (TMPMA)

Particularly favorable examples are tricyclodecanedimethanol diacrylate (A-DCP) represented by formula (A1) below, isobornyl acrylate (IBOA) represented by formula (A2) below, tripropyleneglycol diacrylate (TPGDA) represented by formula (A3) below, dipropyleneglycol diacrylate (DPGDA) represented by formula (A4) below, neopentylglycol diacrylate (NPDA) represented by formula (A5) below, ethoxylated isocyanuric triacrylate (TITA) represented by formula (A6) below, 2-hydroxypropyl diacrylate (HPDA) represented by formula (A7) below, acetalglycol diacrylate (AGDA) represented by formula (A8) below, ditrimethylolpropane tetraacrylate (DTTA) represented by formula (A9) below, ethoxylated 2-mol bisphenol A dimethyl acrylate (EO2BDMA) represented by formula (A10) below, and ethoxylated 3-mol bisphenol A dimethyl acrylate (EO3BMA) represented by formula (A11) below.

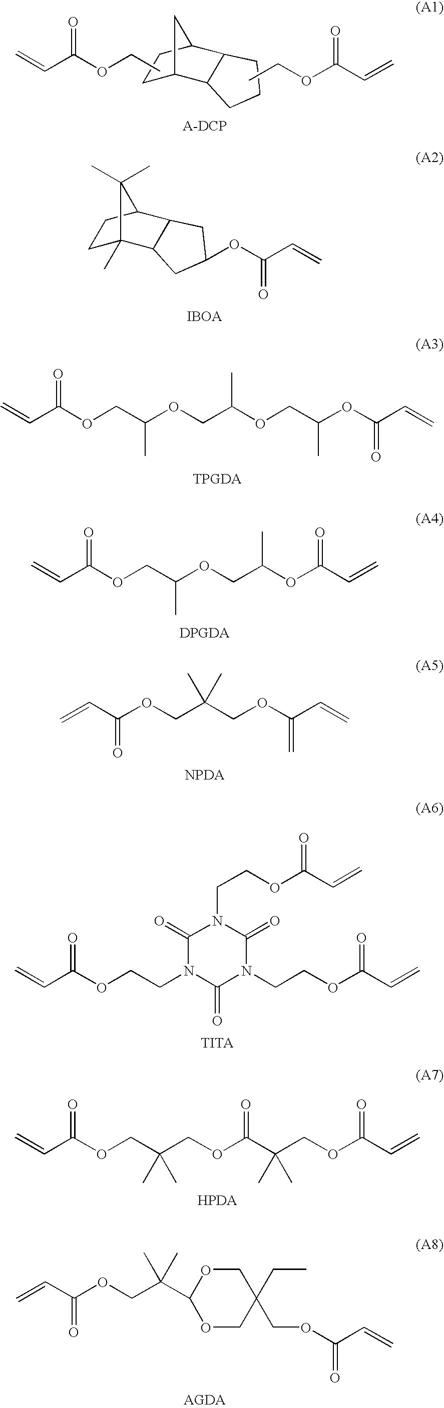

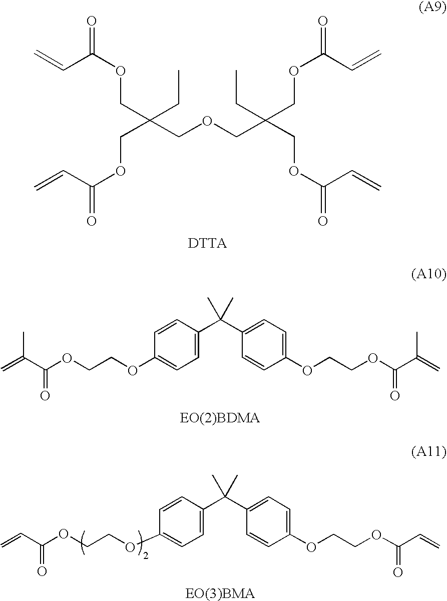

As the oligomer material, it is possible to use an urethane acrylate-based material represented by formula (B1) below, e.g., polyurethane diacrylate (PUDA), or polyurethane hexaacrylate (PUHA) represented by formula (B2) below. Other examples are polymethyl methacrylate (PMMA), polymethyl methacrylate fluoride (PMMA-F), polycarbonate diacrylate, and methyl methacrylate polycarbonate fluoride (PMMA-PC-F).

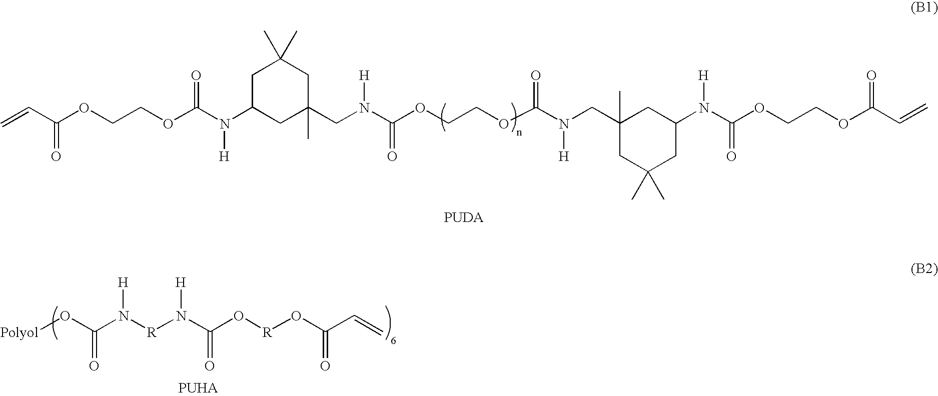

An acrylate phosphate-based material is used as the adhesive. Examples are materials represented by formulas (P1), (P2), and (P3) below.

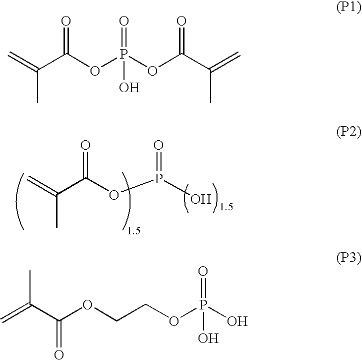

As the polymerization initiator, it is possible to use, e.g., IRGACURE 184 represented by formula (B1) below manufactured by Ciba Specialty Chemicals, or DAROCUR 1173 represented by formula (B2) below manufactured also by Ciba Specialty Chemicals.

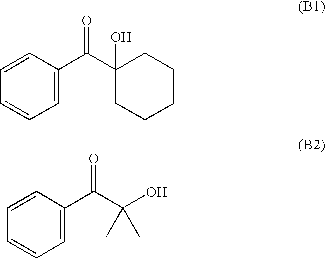

This ultraviolet-curing resin material has a large effect on the coating properties of the L1 dye, and hence has a large effect on the push-pull signal modulation degree of L1.

The ultraviolet-curing resin material also has an influence on the warpage of the L0 substrate.

In order to conduct a test on the ultraviolet-curing resin usable in the present invention, ultraviolet-curing resin material samples 1 to 36 were obtained by using monomers and oligomers shown in Table 1 below, and mixing the monomers and oligomers, additives, and polymerization initiators by combining them as shown in Tables 2 to 5 below. Tables 3 and 5 also show the oxygen content ratios of these materials and the push-pull signal modulation degrees and tilt angles when the materials were used.

TABLE 1

| | C | H | O | N | Total | CHN/O | O/CHN | O/CHON |
|---|---|---|---|---|---|---|---|---|
| ADGA | 17 | 26 | 6 | 0 | 49 | 7.166666667 | 0.139534884 | 12.24489796 |
| IBOA | 13 | 20 | 2 | 0 | 35 | 16.5 | 0.060606061 | 5.714285714 |
| TPGDA | 15 | 24 | 6 | 0 | 45 | 6.5 | 0.153846154 | 13.33333333 |
| TITA | 18 | 23 | 9 | 3 | 53 | 4.888888889 | 0.204545455 | 16.98113208 |
| A-DCP | 18 | 24 | 4 | 0 | 46 | 10.5 | 0.095238095 | 8.695652174 |
| PUDA (n = 5) | 44 | 74 | 12 | 4 | 134 | 10.16666667 | 0.098360656 | 8.955223881 |
| PUHA | 42 | 54 | 36 | 12 | 144 | 3 | 0.333333333 | 25 |
| EO2BDMA | 27 | 32 | 6 | 0 | 65 | 9.833333333 | 0.101694915 | 9.230769231 |
| EO3BMA | 27 | 32 | 7 | 0 | 66 | 8.428571429 | 0.118644068 | 10.60606061 |
| DTTA | 24 | 34 | 9 | 0 | 67 | 6.444444444 | 0.155172414 | 13.43283582 |
| NPDA | 11 | 16 | 4 | 0 | 31 | 6.75 | 0.148148148 | 12.90322581 |
| HPDA | 16 | 24 | 6 | 0 | 46 | 6.666666667 | 0.15 | 13.04347826 |

TABLE 2

| | | Oligomer or | | | |
|---|---|---|---|---|---|
| | Monomer | monomer | Additive 1 | Additive 2 | Additive 3 |
| Sample 1 | AGDA (92) | | | | |
| Sample 2 | A-DCP (90.5) | | P2 (0.5) | | |
| Sample 3 | IBOA (57) | PUDA (38.3) | P3 (0.1) | PA (0.6) | |
| Sample 4 | IBOA (26) | PUDA (43.9) | TPGDA (26) | P3 (0.1) | |
| Sample 5 | TPGDA (10.8) | EO2BDMA (85) | P3 (0.2) | | |
| Sample 6 | TPGDA (9.8) | EO2BDMA (70) | EO3BMA (15) | P3 (0.2) | |
| Sample 7 | IBOA (50) | TITA (6) | PUHA (38.9) | P3 (0.1) | |
| Sample 8 | IBOA (32.9) | TPGDA (17) | PUHA (23) | PUDA (23) | P3 (0.1) |
| Sample 9 | IBOA (50) | PUHA (18.1) | PUDA (27.7) | P3 (0.1) | |
| Sample 10 | IBOA (51) | PUHA (28) | PUDA (16.9) | P3 (0.1) | |
| Sample 11 | IBOA (50) | PUHA (35) | PUDA (10.9) | P3 (0.1) | |
| Sample 12 | ADGA (97) | | | | |
| Sample 13 | ADGA (96) | | | | |
| Sample 14 | ADGA (86) | TPGDA (9.9) | | P3 (0.1) | |
| Sample 15 | ADGA (83) | IBOA (10) | | | |
| Sample 16 | ADGA (83) | IBOA (9.9) | | P3 (0.1) | |
| Sample 17 | ADGA (62) | IBOA (12) | PUDA (19) | P3 (0.1) | |
| Sample 18 | ADGA (73) | IBOA (9.9) | PUDA (10) | P3 (0.1) | |

TABLE 3

| | | | Push- | | |
|---|---|---|---|---|---|
| | | | pull | Radial | Total |
| | Hardener | O/(CHON) | signal | tilt (°) | evaluation |
| Sample 1 | Irg184 (8) | 12.2 | 0.31 | 2.6 | ∘ |
| Sample 2 | Irg184 (9) | 8.7 | 0.06 | 1 | Δ |
| Sample 3 | Dar1173 (4) | 6.686993603 | 0.07 | 0.8 | Δ |
| Sample 4 | Dar1173 (4) | 5.417057569 | 0.07 | 0 | Δ |
| Sample 5 | Dar1173 (4) | 9.286153846 | 0.13 | 2.5 | Δ |
| Sample 6 | Dar1173 (5) | 9.359114219 | 0.14 | 2.5 | Δ |
| Sample 7 | Irg184 (5) | 13.60101078 | 0.27 | 2.5 | ∘ |
| Sample 8 | Irg184 (4) | 11.95636816 | 0.26 | 2.5 | ∘ |
| Sample 9 | Irg184 (4.1) | 9.862739872 | 0.22 | 2.5 | Δ |
| Sample 10 | Irg184 (4) | 11.42771855 | 0.26 | 2.5 | ∘ |
| Sample 11 | Irg184 (4) | 12.58326226 | 0.27 | 2.5 | ∘ |
| Sample 12 | Irg184 (3) | 11.87755102 | 0.26 | 2.5 | ∘ |
| Sample 13 | Dar1173 (4) | 11.75510204 | 0.293 | 2.35 | ∘ |
| Sample 14 | Dar1173 (4) | 11.85061224 | 0.281 | 2.03 | ∘ |
| Sample 15 | Irg184 (7) | 10.73469388 | 0.288 | 1.77 | ∘ |
| Sample 16 | Irg184 (7) | 10.72897959 | 0.267 | 1.71 | ∘ |
| Sample 17 | Irg184 (6.9) | 9.979043558 | 0.24 | 1.85 | Δ |
| Sample 18 | Irg184 (7) | 10.40001218 | 0.289 | 1.78 | ∘ |

TABLE 4

| | | Oligomer or | | | |
|---|---|---|---|---|---|
| | Monomer | monomer | Additive 1 | Additive 2 | Additive 3 |
| Sample 19 | ADGA (62) | IBOA (12) | PUDA (19) | P3 (0.1) | |
| Sample 20 | ADGA (23.7) | IBOA (35) | PUHA (37.5) | P3 (0.1) | |
| Sample 21 | TITA (12.4) | IBOA (43.3) | PUHA (37.5) | P3 (0.1) | |
| Sample 22 | ADGA (67) | IBOA (25.9) | | P3 (0.1) | |
| Sample 23 | ADGA (84) | HPDA (10) | | P3 (0.1) | |
| Sample 24 | IBOA (25) | HPDA (24) | PUHA (44.9) | P3 (0.1) | |
| Sample 25 | IBOA (25) | HPDA (34) | PUHA (34.9) | P3 (0.1) | |
| Sample 26 | HPDA (54.9) | DTTA (5) | PUHA (34) | P3 (0.1) | |
| Sample 27 | HPDA (54.9) | DTTA (10) | PUHA (29) | P3 (0.1) | |
| Sample 28 | HPDA (60) | DTTA (13.7) | PMMA-F (20.2) | P3 (0.1) | |
| Sample 29 | ADGA (80) | DTTA (13.9) | | P3 (0.1) | |
| Sample 30 | IBOA (20) | HPDA (25.9) | DTTA (10) | PUHA (28) | PMMA (10) |
| Sample 31 | HPDA (45.9) | DTTA (10) | PUHA (28) | PMMA (10) | P3 (0.1) |
| Sample 32 | IBOA (15) | ADGA (53.9) | DTTA (14) | PMMA (11) | P3 (0.1) |
| Sample 33 | IBOA (15) | ADGA (50.9) | DTTA (17) | PMMA (11) | P3 (0.1) |
| Sample 34 | TPGDA (50) | TITA (6) | PUHA (38.9) | P3 (0.1) | |
| Sample 35 | ADGA (86) | TPGDA (10) | | | |
| Sample 36 | ADGA (93) | | | | |

TABLE 5

| | | | | Push-pull | Radial | Total |
|---|---|---|---|---|---|---|
| | Hardener | | O/(CHON) | signal | tilt (°) | evaluation |
| Sample 19 | Irg184 (4) | Dar1173 (2.9) | 9.979043558 | 0.23 | 2.1 | Δ |
| Sample 20 | Irg184 (6) | | 14.27704082 | 0.318 | 3.1 | Δ |
| Sample 21 | Irg184 (6.7) | | 13.95494609 | 0.308 | 2.9 | Δ |
| Sample 22 | Irg184 (7) | | 9.684081633 | 0.22 | 1.27 | Δ |
| Sample 23 | Dar1173 (5.9) | | 11.59006211 | 0.3 | 2.5 | ◯ |
| Sample 24 | Irg184 (6) | | 15.78400621 | 0.36 | 4.2 | Δ |
| Sample 25 | Irg184 (6) | | 14.58835404 | 0.34 | 3.2 | Δ |
| Sample 26 | Irg184 (6) | | 16.33251136 | 0.35 | 4.3 | Δ |
| Sample 27 | Irg184 (6) | | 15.75415315 | 0.34 | 3 | Δ |
| Sample 28 | Irg184 (6) | | 9.001168073 | 0.21 | 1.84 | Δ |
| Sample 29 | Irg184 (6) | | 11.66308255 | 0.39 | 2.54 | ⊚ |
| Sample 30 | P3 (0.1) | Irg184 (6) | 12.86440159 | 0.3 | 2.49 | ◯ |
| Sample 31 | Irg184 (6) | | 14.3302401 | 0.35 | 2.54 | ◯ |
| Sample 32 | Irg184 (6) | | 9.337739872 | 0.19 | 2.5 | Δ |
| Sample 33 | Irg184 (6) | | 9.373378008 | 0.15 | 2.48 | Δ |
| Sample 34 | Irg184 (5) | | 17.41053459 | Peel NG | | X |
| Sample 35 | Dar1173 (4) | | 11.86394558 | 0.27 | 2.3 | ◯ |
| Sample 36 | Irg184 (7) | | 11.3877551 | 0.28 | 2.4 | ◯ |

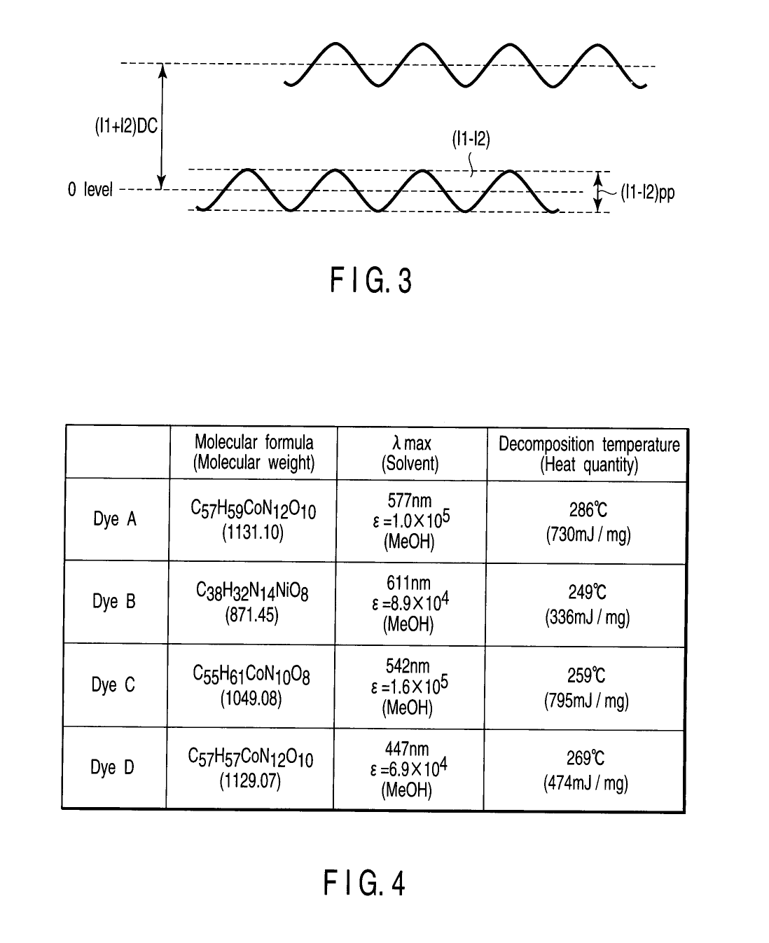

Important evaluation indices were selected. The tracking error signal modulation degree (push-pull signal) of L1 was particularly important. This index is defined by the value obtained by dividing the difference signal amplitude (I1−I2)pp by the average level (I1+I2)DC of sum signals shown in FIG. 3. That is, push-pull signal=(I1−I2)pp/(I1+I2)DC. This value must be 0.26 or more. The conducted experiment revealed that since the critical surface tension largely changed in accordance with the ultraviolet-curing resin material, the degrees to which the dye was applied and buried in a groove also largely changed. This largely changed the push-pull signal of L1. When the value was smaller than 0.26, a tracking error of L1 sometimes occurred.

The next important index was the inclination angle (radial tilt) corresponding to the warpage amount of the L0 substrate after the transfer of the ultraviolet-curing resin. The conducted experiment revealed that the cure shrinkage stress of the ultraviolet-curing resin material largely changed, and this largely changed the warpage of the L0 substrate. When the value was 2.6° or more, it was often impossible to decrease the radial tilt of the laminated disks to 0.7° or less, and this adversely affected the tracking characteristics and signal characteristics of the completed double-layer disk. As a consequence, the data error rate often worsened.

When the various tests described above were conducted on the ultraviolet-curing resins, sample 34 was NG because the L1 substrate could not be removed. Also, a tilt was sometimes large although the push-pull signal was 0.26 or more. Sample 29 was the best.

As sample 34 described in Tables 4 and 5 shows, when the oxygen content ratio exceeded 14 atm %, it was often impossible to remove the polycarbonate substrate from the ultraviolet-curing resin layer. Alternatively, the tilt angle increased to 3° or more to cause defective lamination.

Therefore, more favorable disks can be obtained by selecting ultraviolet-curing resins by which the oxygen content ratio is 11 atm % or more, or preferably 11 to 14 atm %.

In the above example, the L0 dye was prepared by mixing the dyes D5 and D6 at a ratio of 9:1, and the L1 dye was prepared by mixing the dyes D2 and D3 at a ratio of 1:1.

It is also possible to use other dyes, e.g., D1 and D4.

A write once information recording medium to be explained in this embodiment has a disk-like transparent resin substrate made of a synthetic resin material such as polycarbonate. This transparent resin substrate has concentric or spiral grooves. The transparent resin substrate can be manufactured by injection molding using a stamper.

A recording film containing an organic dye is formed on the transparent resin substrate so as to fill the grooves. The organic dye forming this recording film has a maximum absorption wavelength region shifted to wavelengths longer than the recording wavelength (405 nm). Also, the organic dye is designed not to extinguish absorption but to have a considerable light absorption in the recording wavelength region.

This decreases the light reflectance when a recording laser beam performs focusing or tracking on tracks before information recording. The laser beam decomposes the dye and decreases the absorbance, so the light reflectance of a recording mark increases. This realizes so-called L-to-H characteristics by which the light reflectance of a recording mark formed by irradiation with a laser beam is higher than a light reflectance before the laser beam irradiation.

Note that the generated heat sometimes deforms the transparent resin substrate, particularly, the bottom of the groove. This may produce a phase difference in reflected light.

When dissolved in a solvent, the organic dye described above can be easily applied in the form of a liquid to the surface of the transparent resin substrate by spin coating. In this case, the film thickness can be accurately managed by controlling the ratio of dilution by the solvent and the rotational speed of spin coating.

The organic dye is a dye having a dye portion and counter ion (anion) portion or an organic metal complex. Examples of the dye portion are a cyanine dye and styryl dye. A cyanine dye and styryl dye are particularly suitable because the absorbance to the recording wavelength can be easily controlled.

In particular, when a monomethine cyanine dye having a monomethine chain is used and the recording film applied on the transparent resin substrate is thinned, the maximum absorption and the absorbance in the recording wavelength region (400 to 405 nm) can be readily adjusted to nearly 0.3 to 0.5, and to nearly 0.4. This makes it possible to improve the recording/playback characteristics, and increase the light reflectance and recording sensitivity.

The anion portion is preferably an organic metal complex from the viewpoint of the light stability as well. An organic metal complex containing cobalt or nickel as a central metal is particularly superior in light stability.

Recording can be performed with little deformation by using an organic metal complex instead of the dye having the dye portion and anion portion. Especially, the organic metal complex can be used as the organic dye in the first layer.

An azo metal complex is most favorable and has high solubility when 2,2,3,3-tetrafluoro-1-propanol (TFP) is used as a solvent. This facilitates preparation of a solution for spin coating. In addition, since the solution can be recycled after spin coating, the manufacturing cost of the information recording medium can be reduced.

Note that an organic metal complex can be used as a Low-to-High type organic dye for L0. The organic metal complex can be dissolved in a TFP solution and spin-coated. An azo metal complex is particularly favorable as the L0 recording layer made of a thin Ag alloy layer because deformation rarely occurs after recording. Although Cu, Ni, Co, Zn, Fe, Al, Ti, V, Cr, or Y can be used as a central metal, Cu, Ni, and Co are especially preferable in playback light resistance. Cu has no genetic toxicity and improves the quality of a recording/playback signal.

Various materials can be used as ligands surrounding the central metal. Examples are dyes represented by formulas (D1) to (D6) below. It is also possible to form another structure by combining these ligands.

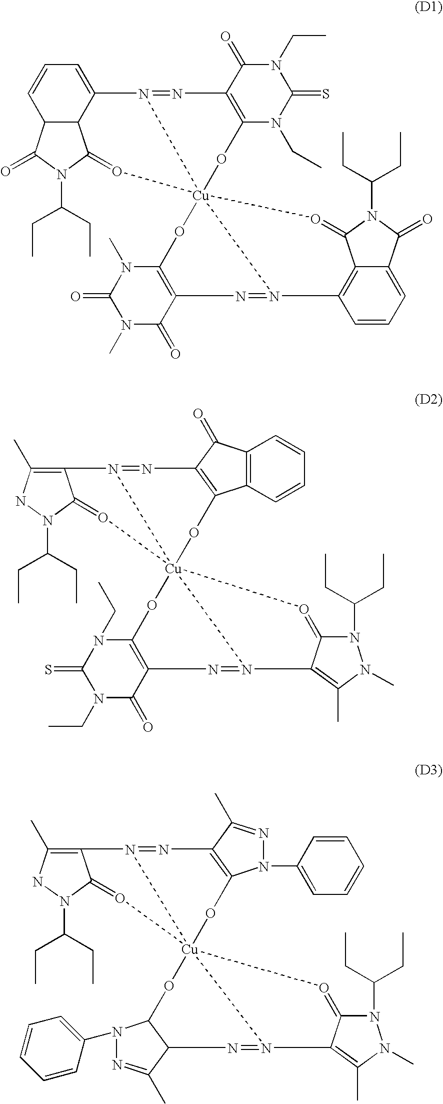

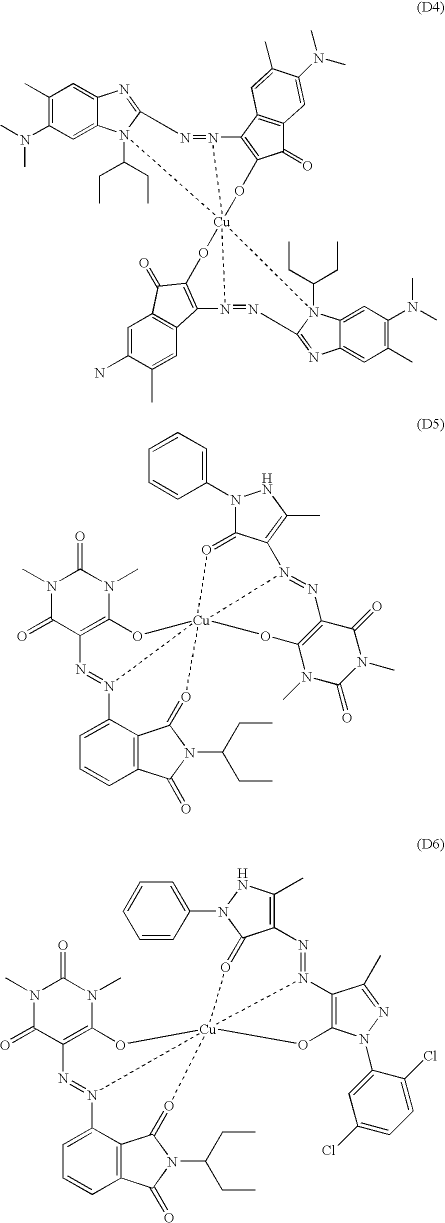

These azo metal complexes can also be used in the second organic dye layer for L1. Since the silver film or silver alloy film for L1 is thick, even a dye which easily deforms can be used. It is also possible to use a cationic dye or anionic dye. A dye for L1 must have a high recording sensitivity.

FIG. 4 shows dyes A to D as four examples of an organic dye material usable in the second organic dye layer. The dye A has a styryl dye as a dye portion (cation portion) and azo metal complex 1 as an anion portion. The dye C has a styryl dye as a dye portion (cation portion) and azo metal complex 2 as an anion portion. The dye D has a monomethinecyanine dye as a dye portion (cation portion) and azo metal complex 1 as an anion portion. Note that an organic metal complex can also be singly used. As an example, the dye B is a nickel complex dye.

The disk substrate coated with the thin organic dye film by spin coating is heated to a temperature of about 80° C. on a hot plate or in a clean oven, thereby drying the dye. Then, a thin metal film serving as a light reflecting film is formed on the thin organic dye film by sputtering. Examples of this metal reflecting film material are Au, Ag, Cu, Al, and alloys of these metals.

After that, the metal film is spin-coated with an ultraviolet-curing resin, and a protective disk substrate is adhered, thereby manufacturing a write once optical disk as a write once information recording medium.

Formula E1 indicates the formula of the styryl dye as the dye portions of the dyes A and C. Formula E2 indicates the formula of the azo metal complex as the anion portions of the dyes A and C. Formula E3 indicates the formula of the monomethinecyanine dye as the dye portion of the dye D. Formula E4 indicates the formula of the azo metal complex as the anion portion of the dye D.

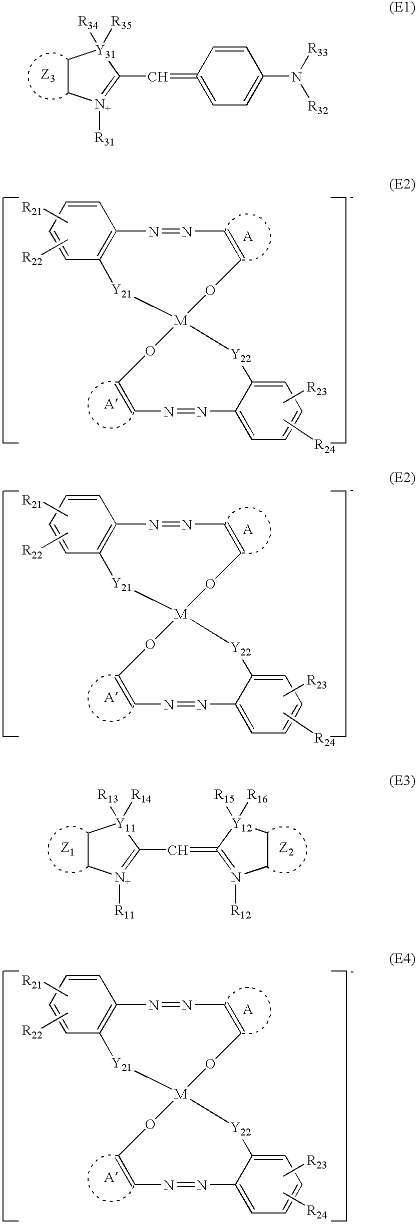

In the formula of the styryl dye, Z₃ represents an aromatic ring, and this aromatic may have a substituent group. Y₃₁ represents a carbon atom or hetero atom. R₃₁, R₃₂, and R₃₃ represent the same aliphatic hydrocarbon group or different aliphatic hydrocarbon groups, and these aliphatic hydrocarbon groups may have a substituent group. R₃₄ and R₃₅ each independently represent a hydrogen atom or appropriate substituent group. When Y₃₁ is a hetero atom, one or both of R₃₄ and R₃₅ do not exist.

In the formula of the monomethinecyanine dye, Z₁ and Z₂ represent the same aromatic ring or different aromatic rings, and these aromatic rings may have a substituent group. Y₁₁ and Y₁₂ each independently represent a carbon atom or hetero atom. R₁₁ and R₁₂ represent aliphatic hydrocarbon groups, and these aliphatic hydrocarbon groups may have a substituent group. R₁₃, R₁₄, R₁₅, and R₁₆ each independently represent a hydrogen atom or appropriate substituent group. When Y₁₁ and Y₁₂ are hetero atoms, some or all of R₁₃, R₁₄, R₁₅, and R₁₆ do not exist.

Examples of the monomethinecyanine dye used in this embodiment are dyes obtained by bonding identical or different cyclic nuclei which may have one or a plurality of substituent groups to the two ends of a monomethine chain which may have one or a plurality of substituent groups. Examples of the cyclic nuclei are an imidazoline ring, imidazole ring, benzoimidazole ring, α-naphthoimidazole ring, β-naphthoimidazole ring, indole ring, isoindole ring, indolenine ring, isoindolenine ring, benzoindolenine ring, pyridinoindolenine ring, oxazoline ring, oxazole ring, isoxazole ring, benzoxazole ring, pyridinoxazole ring, α-naphthoxazole ring, β-naphthoxazole ring, selenazoline ring, selenazole ring, benzoselenazole ring, α-naphthoselenazole ring, β-naphthoselenazole ring, thiazoline ring, thiazole ring, isothiazole ring, benzothiazole ring, α-naphthothiazole ring, β-naphthothiazole ring, tellurazoline ring, tellurazole ring, benzotellurazole ring, α-naphthotellurazole ring, β-naphthotellurazole ring, acridine ring, anthracene ring, isoquinoline ring, isopyrrole ring, imidanoxaline ring, indandione ring, indazole ring, indaline ring, oxadiazole ring, carbazole ring, xanthene ring, quinazoline ring, quinoxaline ring, quinoline ring, chroman ring, cyclohexanedione ring, cyclopentanedione ring, cinnoline ring, thiodiazole ring, thioxazolidone ring, thiophene ring, thionaphthene ring, thiobarbituric acid ring, thiohydantoin ring, tetrazole ring, triazine ring, naphthalene ring, naphthyridine ring, piperazine ring, pyrazine ring, pyrazole ring, pyrazoline ring, pyrazolidine ring, pyrazolone ring, pyran ring, pyridine ring, pyridazine ring, pyrimidine ring, pyrylium ring, pyrrolidine ring, pyrroline ring, pyrrole ring, phenazine ring, phenanthrizine ring, phenanthrene ring, phenanthroline ring, phtharazine ring, puterizine ring, furazane ring, furan ring, purine ring, benzene ring, benzoxazine ring, benzopyran ring, morpholine ring, and rhodanine ring.

In the formulas of the monomethinecyanine dye and styryl dye, Z₁ to Z₃ represent aromatic rings such as a benzene ring, naphthalene ring, pyridine ring, quinoline ring, and quinoxaline ring, and these aromatic rings may have one or a plurality of substituent groups. Examples are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, 5-methylhexyl group, heptyl group, and octyl group; alicyclic hydrocarbon groups such as a cyclopropyl group, cyclobutyl group, cyclopentyl group, and cyclohexyl group; aromatic hydrocarbon groups such as a phenyl group, biphenylyl group, o-tolyl group, m-tolyl group, p-tolyl group, xylyl group, mesityl group, o-cumenyl group, m-cumenyl group, and p-cumenyl group; ether groups such as a methoxy group, trifluoromethoxy group, ethoxy group, propoxy group, isopropoxy group, butoxy group, sec-butoxy group, tert-butoxy group, pentyloxy group, phenoxy group, and benzoyloxy group; ester groups such as a methoxycarbonyl group, trifluoromethoxycarbonyl group, ethoxycarbonyl group, propoxycarbonyl group, acetoxy group, and benzoyloxy group; halogen groups such as a fluoro group, chloro group, bromo group, and iodo group; thio groups such as a methylthio group, ethylthio group, propylthio group, butylthio group, and phenylthio group; sulfamoyl groups such as a methylsulfamoyl group, dimethylsulfamoyl group, ethylsulfamoyl group, diethylsulfamoyl group, propylsulfamoyl group, dipropylsulfamoyl group, butylsulfamoyl group, and dibutylsulfamoyl group; amino groups such as a primary amino group, methylamino group, dimethylamino group, ethylamino group, diethylamino group, propylamino group, dipropylamino group, isopropylamino group, diisopropylamino group, butylamino group, dibutylamino group, and piperidino group; carbamoyl groups such as a methylcarbamoyl group, dimethylcarbamoyl group, ethylcarbamoyl group, diethylcarbamoyl group, propylcarbamoyl group, and dipropylcarbamoyl group; and a hydroxy group, carboxy group, cyano group, nitro group, sulfino group, sulfo group, and mesyl group. Note that in these formulas, Z₁ and Z₂ can be the same or different.

In the formulas of the monomethinecyanine dye and styryl dye, Y₁₁, Y₁₂, and Y₃₁ each represent a carbon atom or hetero atom. Examples of the hetero atom are group-XV and group-XVI atoms in the periodic table, such as a nitrogen atom, oxygen atom, sulfur atom, selenium atom, and tellurium atom. Note that the carbon atom represented by Y₁₁, Y₁₂, or Y₃₁ may also be an atomic group mainly containing two carbon atoms, such as an ethylene group or vinylene group. Note also that Y₁₁ and Y₁₂ in the formula of the monomethinecyanine dye can be the same or different.

In the formulas of the monomethinecyanine dye and styryl dye, R₁₁, R₁₂, R₁₃, R₃₂, and R₃₃ each represent an aliphatic hydrocarbon group. Examples of the aliphatic hydrocarbon group are a methyl group, ethyl group, propyl group, isopropyl group, isopropenyl group, 1-propenyl group, 2-propenyl group, butyl group, isobutyl group, sec-butyl group, tert-butyl group, 2-butenyl group, 1,3-butadienyl group, pentyl group, isopentyl group, neopentyl group, tert-pentyl group, 1-methylpentyl group, 2-methylpentyl group, 2-pentenyl group, hexyl group, isohexyl group, 5-methylhexyl group, heptyl group, and octyl group. This aliphatic hydrocarbon group may have one or a plurality of substituent groups similar to those of Z₁ to Z₃.

Note that R₁₁ and R₁₂ in the formula of the monomethinecyanine dye can be the same or different, and R₁₃, R₃₂, and R₃₃ in the formula of the styryl dye can also be the same or different.

R₁₃ to R₁₆, R₃₄, and R₃₅ in the formulas of the monomethinecyanine dye and styryl dye each independently represent a hydrogen atom or appropriate substituent group in the individual formulas. Examples of the substituent group are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, 5-methylhexyl group, heptyl group, and octyl group; ether groups such as methoxy group, trifluoromethoxy group, ethoxy group, propoxy group, butoxy group, tert-butoxy group, pentyloxy group, phenoxy group, and benzoyloxy group; halogen groups such as a fluoro group, chloro group, bromo group, and iodo group; and a hydroxy group, carboxy group, cyano group, and nitro group. Note that when Y₁₁, Y₁₂, and Y₃₁ are hetero atoms in the formulas of the monomethinecyanine dye and styryl dye, some or all of R₁₃ to R₁₆ in Z₁ and Z₂ and one or both of R₃₄ and R₃₅ in Z₃ do not exist.

In the formula of the azo metal complex, A and A′ represent 5- to 10-membered heterocyclic groups which are the same or different and each contain one or a plurality of hetero atoms selected from a nitrogen atom, oxygen atom, sulfur atom, selenium atom, and tellurium atom. Examples of the heterocyclic groups are a furyl group, thienyl group, pyrrolyl group, pyridyl group, piperidino group, piperidyl group, quinolyl group, and isoxazolyl group. This heterocyclic group may have one or a plurality of substituent groups. Examples are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, and 5-methylhexyl group; ester groups such as a methoxycarbonyl group, trifluoromethoxycarbonyl group, ethoxycarbonyl group, propoxycarbonyl group, acetoxy group, trifluoroacetoxy group, and benzoyloxy group; aromatic hydrocarbon groups such as a phenyl group, biphenylyl group, o-tolyl group, m-tolyl group, p-tolyl group, o-cumenyl group, m-cumenyl group, p-cumenyl group, xylyl group, mesityl group, styryl group, cinnamoyl group, and naphthyl group; and a carboxy group, hydroxy group, cyano group, and nitro group.

Note that an azo compound forming the azo-based organic metal complex represented by the formula can be obtained in accordance with the conventional method by reacting a diazonium salt having R₂₁ and R₂₂ or R₂₃ and R₂₄ corresponding to the formula with a heterocyclic compound having an active methylene group adjacent to a carbonyl group in the molecule. Examples of the heterocyclic compound are an isoxazolone compound, oxazolone compound, thionaphthene compound, pyrazolone compound, barbituric acid compound, hydantoin compound, and rhodanine compound. Y₂₁ and Y₂₂ represent hetero atoms which are the same or different and selected from group-XVI elements in the periodic table, e.g., an oxygen atom, sulfur atom, selenium atom, and tellurium atom.

The azo metal complex represented by the formula is normally used in the form of a metal complex in which one or a plurality of azo metal complexes are coordinated around a metal (central atom). Examples of a metal element serving as the central atom are scandium, yttrium, titanium, zirconium, hafnium, vanadium, niobium, tantalum, chromium, molybdenum, tungsten, manganese, technetium, rhenium, iron, ruthenium, osmium, rhodium, iridium, nickel, palladium, platinum, copper, silver, gold, zinc, cadmium, and mercury. More preferably, cobalt is frequently used among other metals.

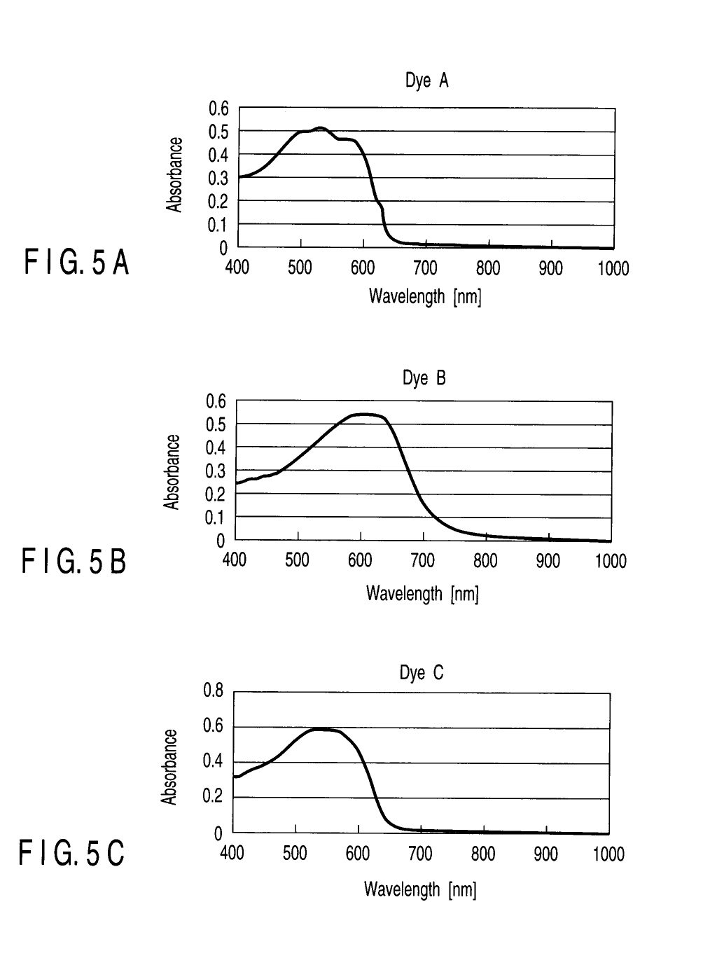

FIG. 5A shows the change in absorbance of the dye A with respect to the wavelength of an emitted laser beam. FIG. 5B shows the change in absorbance of the dye B with respect to the wavelength of an emitted laser beam. FIG. 5C shows the change in absorbance of the dye C with respect to the wavelength of an emitted laser beam.

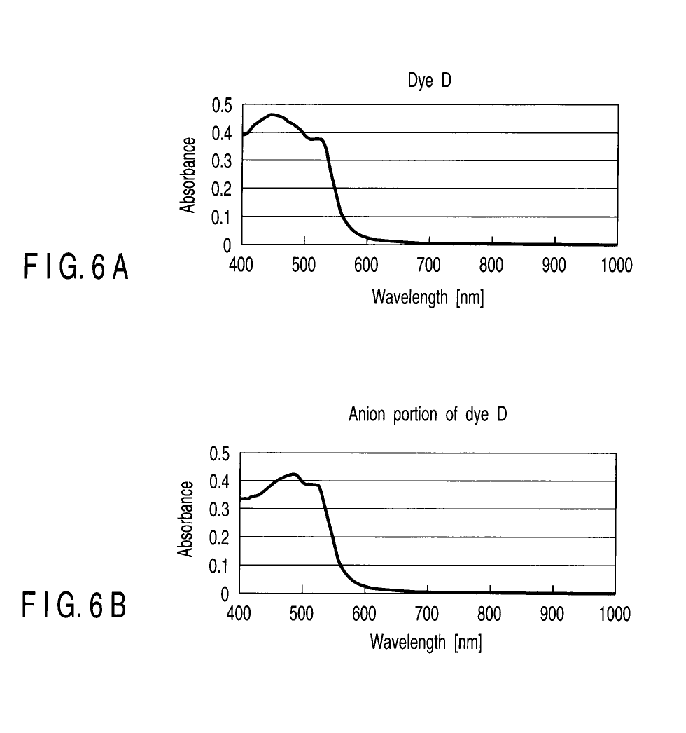

FIG. 6A shows the change in absorbance of the dye D with respect to the wavelength of an emitted laser beam. FIG. 6B shows the change in absorbance of the anion portion of the dye D with respect to the wavelength of an emitted laser beam.

As is evident from the characteristics shown in FIGS. 5A to 6B, the dyes A to D have maximum absorption wavelength regions shifted to wavelengths longer than the recording wavelength (405 nm). The write once optical disk explained in this embodiment comprises the recording film containing the organic dye having the characteristics as described above, and has the so-called L-to-H characteristics by which the light reflectance after laser beam irradiation is higher than that before the laser beam irradiation. Even when a short-wavelength laser beam such as a blue laser is used, therefore, this write once optical disk is superior in, e.g., storage durability, playback signal S/N ratio, and bit error rate, and capable of recording and playing back information at a high density with performance on a highly practical level.

That is, in this write once optical disk, the maximum absorption wavelength of the recording film containing the organic dye is longer than the wavelength of the recording laser beam. Since this reduces the absorption of short-wavelength light such as ultraviolet radiation, the optical stability and the reliability of information recording/playback increase.

Also, since the light reflectance is low when information is recorded, no crosswrite occurs owing to reflective diffusion. Therefore, even when information is recorded on an adjacent track, it is possible to reduce the deterioration of the playback signal S/N ratio and bit error rate. Furthermore, the contrast and resolution of a recording mark can be kept high even against heat. This facilitates recording sensitivity design.

Note that the absorbance at the recording wavelength (405 nm) can be 0.3 or more in order to obtain good L-to-H characteristics. This absorbance can be 0.4 or more.

The organic dyes used were the four dyes A to D described earlier, and seven dye mixtures F to L formed by mixing two or more types of the dyes A to D.

The dye mixture F was obtained by adding 5% of the dye B to the dye D, i.e., mixing 0.05 g of the dye B in 1 g of the dye D.

The dye mixture G was obtained by mixing a monomethinecyanine dye (anion portion azo metal complex 3) as the dye E in the dye D at a ratio of 7:3 (=D:E), and adding 5% of the dye B, i.e., mixing 0.05 g of the dye B in 1 g of a dye obtained by mixing the dyes D and E at a ratio of 7:3.

The dye mixture H was obtained by mixing the dye A in the dye D at a ratio of 1:1 (=D:A).

The dye mixture I was obtained by adding 10% of the dye B to the dye D, i.e., mixing 0.10 g of the dye B in 1 g of the dye D.

The dye mixture J was obtained by adding 15% of the dye B to the dye D, i.e., mixing 0.15 g of the dye B in 1 g of the dye D.

The dye mixture K was obtained by adding anion portion azo metal complex 1 to the dye D to increase the anion ratio to dye portion: anion potion=1:1.5, and adding 15% of the dye B.

The dye mixture L was obtained by adding anion portion azo metal complex 1 to the dye D to increase the anion ratio to dye portion: anion potion=1:2.0, and adding 15% of the dye B.

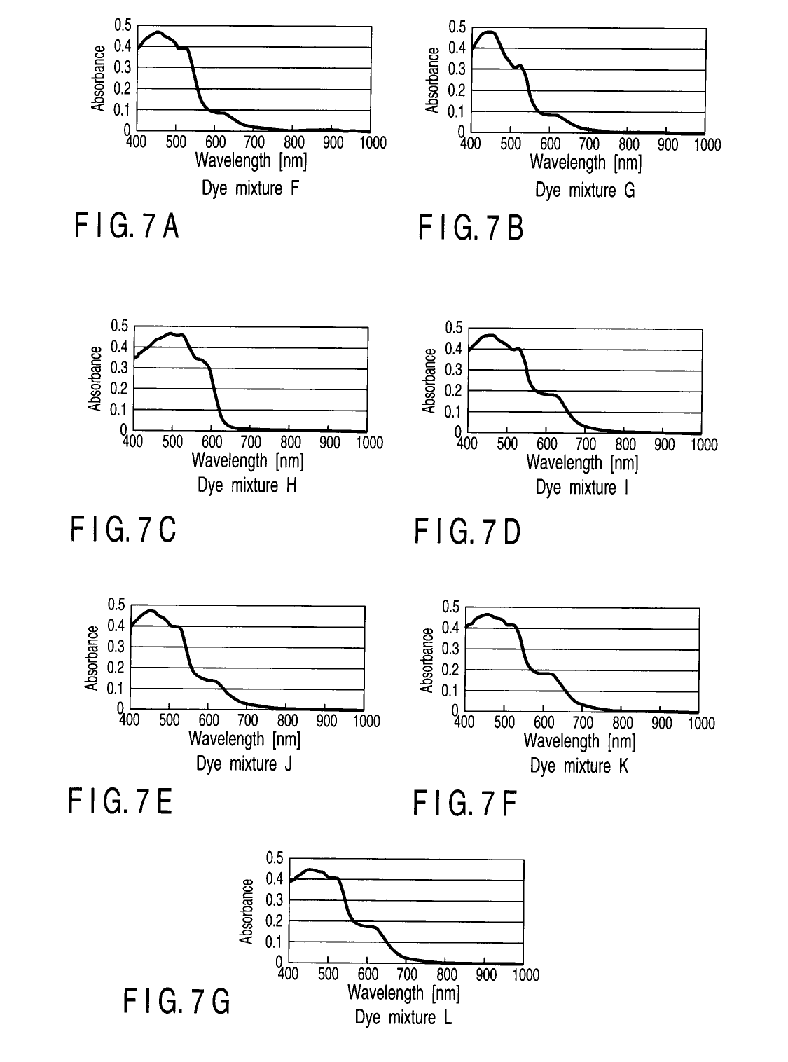

FIGS. 7A to 7G each show the change in absorbance of a corresponding one of the dye mixtures F to L with respect to the wavelength of an emitted laser. The dye mixtures F to L had maximum absorption wavelength regions shifted to wavelengths longer than the recording wavelength (405 nm), and the absorbance of each dye mixture at the recording wavelength (405 nm) was about 0.4.

Write once information recording media 28 were formed following the same procedures as above by using the 11 types of the organic dyes A to D and F to L described above, and evaluation tests can be conducted by performing recording and playback on a groove tracks Gt of these media. The evaluation apparatus used can be an information recording medium evaluation apparatus manufactured by Pulstec.

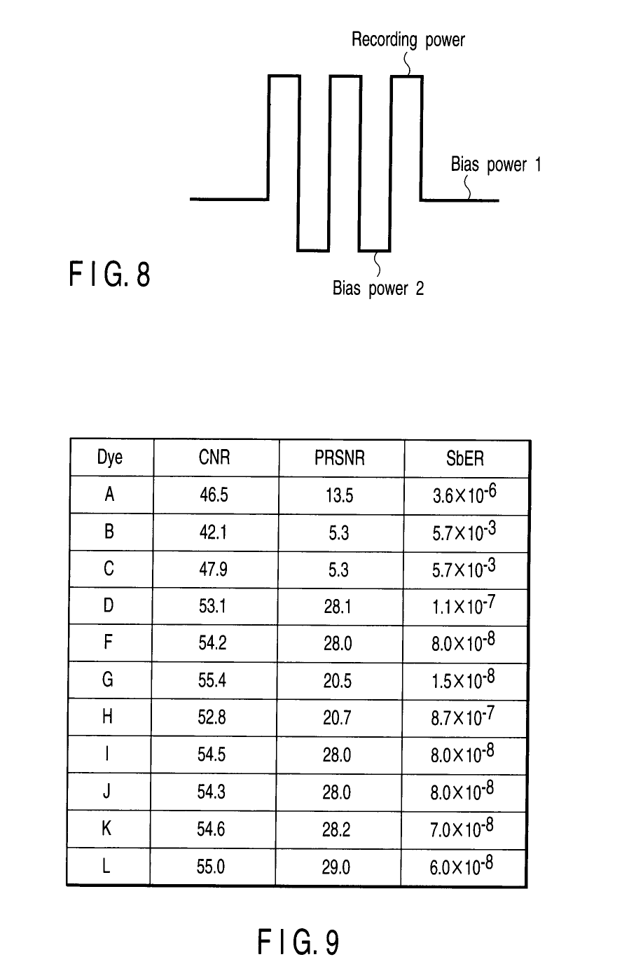

The testing conditions were that the objective lens numerical aperture NA of an optical head 29 was 0.65, the wavelength of the recording/playback laser beam was 405 nm, and the recording/playback linear velocity was 6.61 m/sec. A recording signal was random data having undergone 8-12 modulation, and had a waveform to be recorded by a constant recording power and two types of bias powers 1 and 2 as shown in FIG. 8.

The track pitch was 400 nm, a groove width Gw was “1.1” with respect to “1” as a land width Lw, the wobble amplitude of the groove track Gt was 14 nm, and a groove depth Gh was 90 nm. Note that wobble recording of address information was done by using wobble phase modulation.

The measured evaluation characteristics were three characteristics: a carrier-to-noise ratio CNR of a playback signal, a partial response signal-to-noise ratio PRSNR, and a simulated bit error rate SbER. The PRSNR can be 15 or more. The SbER can be 5.0×10⁻⁵ or less.

The PRSNR and SbER can be measured with information being recorded on adjacent tracks.

FIG. 9 shows the measurement results of the write once information recording media 28 using the dyes A to D and F to L. The measurement results shown in FIG. 9 indicate that the measurement results of the CNR, PRSNR, and SbER of the write once information recording media 28 using the dyes B and C were unsatisfactory.

By contrast, good measurement results were obtained by the write once information recording media 28 using the dyes A, D, F, G, H, I, J, K, and L. Although the measurement results of the write once information recording medium 28 using the dye A were preferable, those of the write once information recording medium 28 using the dye D were particularly preferable. Furthermore, the measurement results of the write once information recording media 28 using the dyes F, I, J, K, and L were excellent.

Then, tests for evaluating the degrees of deterioration caused by repetitive playback were conducted on the write once information recording media 28 using the dyes D, F, G, H, I, J, K, and L for which the measurement results were good. That is, the degrees of deterioration of the PRSNR and SbER were measured by playing back information 10,000 times by using a 0.8-mW playback laser beam.

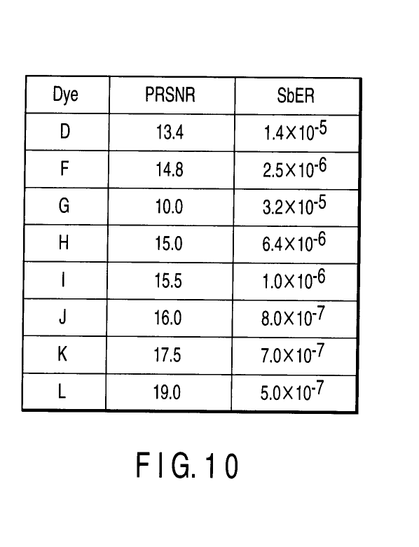

FIG. 10 shows the measurement results of the write once information recording media 28 using the dyes D, F, G, H, I, J, K, and L. As shown in FIG. 10, the measurement results of both the PRSNR and SbER of the write once information recording medium 28 using the dye G were poor. The measurement results of the write once information recording media 28 using the dyes F, H, I, J, K, and L were better than those of the write once information recording medium 28 using the dye D.

The measurement results of the write once information recording media 28 using the dyes J, K, and L were particularly preferable, and those of the write once information recording medium 28 using the dye L were most preferable.

From the foregoing, the organic dye material used in the recording film preferably has a styryl dye or monomethinecyanine dye in the dye portion, and an azo metal complex in the anion portion.

Also, a dye mixture of a styryl dye and monomethinecyanine dye is favorable. Furthermore, a dye containing a nickel metal complex has high quality. Moreover, a dye in which the mixing ratio of the azo metal complex in the anion portion is high has a high playback light resistance.

The shape of a groove as a recording/playback track of the write once optical disk has a large effect on the recording/playback characteristics. The present inventors made extensive studies, and have found that the relationship between the groove width and land width is particularly important.

That is, if the groove width is equal to or smaller than the land width, the playback signal S/N ratio and bit error rate of recorded information often deteriorate. In other words, when the groove width is larger than the land width, good recording/playback characteristics can be obtained.

Also, to record information on a writable optical disk, various pieces of address information such as a track number, sector number, segment number, and ECC (Error Checking and Correcting) block address number must be prerecorded on the optical disk.

A means for recording these pieces of address information can be implemented by wobbling (zigzagging) the groove in the radial direction of the optical disk. That is, the address information can be recorded by wobble by using, e.g., a means for modulating the wobble frequency in accordance with the address information, a means for modulating the wobble amplitude in accordance with the address information, a means for modulating the wobble phase in accordance with the address information, or a means for modulating the wobble polarity reversing interval in accordance with the address information. It is also possible to use a means which uses not only the wobble groove but also the change in land height, i.e., a means for burying a prepit in the land.

The address information can be played back by reading a push-pull signal after tracking. The quality of the read wobble signal itself is evaluated by a normalized wobble amplitude NWS and wobble CNR (Carrier-to-Noise Ratio) (=wobble NBSNR: Narrow Band Signal-to-Noise Ratio).

The normalized wobble amplitude NWS can be 0.10 or more. The NWS can also be 0.10 to 0.45. More preferably, the NWS can be 0.10 to 0.25. Also, the wobble NBSNR can be 18 dB or more. The wobble NBSNR is 26 dB or more.

Note that the wobble signal itself has an influence on the bit error rate of recorded information, so the amplitude of the signal must be held within a certain range. Since this wobble amplitude range changes in accordance with an organic dye material used, it is necessary to set an optimum range capable of achieving good L-to-H characteristics.

Note also that not only the wobble amplitude but also the groove depth has a large influence on the recording/playback characteristics.

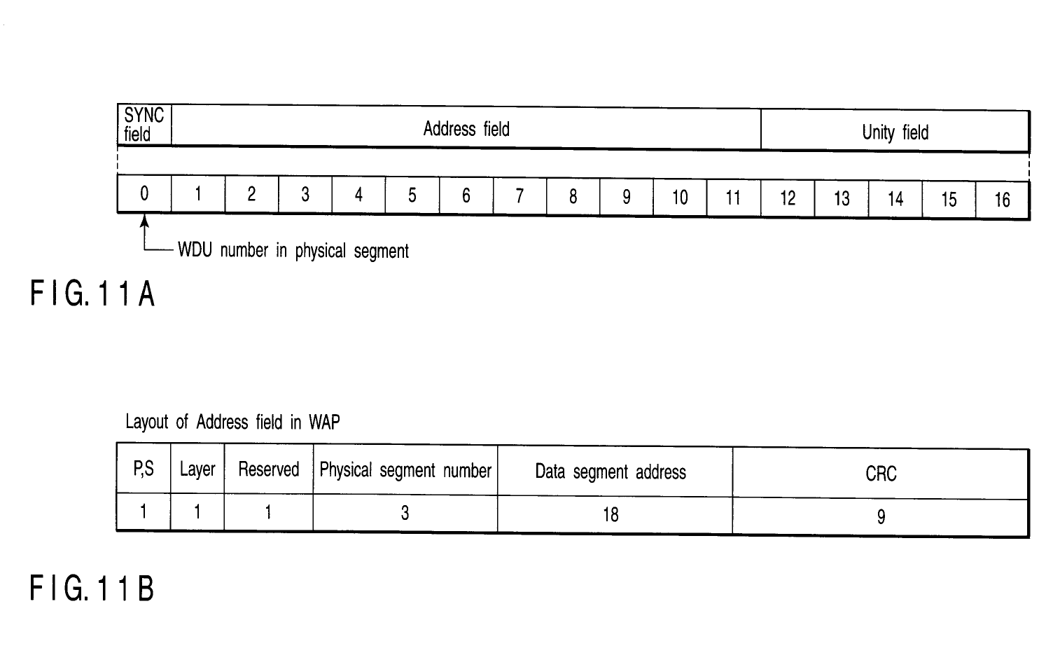

Wobble address data configurations as shown in FIGS. 11A and 11B are convenient for a Low-to-High polarity disk. The wobble frequency is about 696.7742 kHz when the playback linear velocity is 6.61 m/sec. When the channel bit rate of recorded data is 64.80 Mbps, a 93-channel bit length is one period of wobble.

As shown in FIG. 11A, a synchronization field (SYNC field), address field, and unity field form one physical segment (sector) of address data, and the address data has a total of 17 wobble data units WDU.

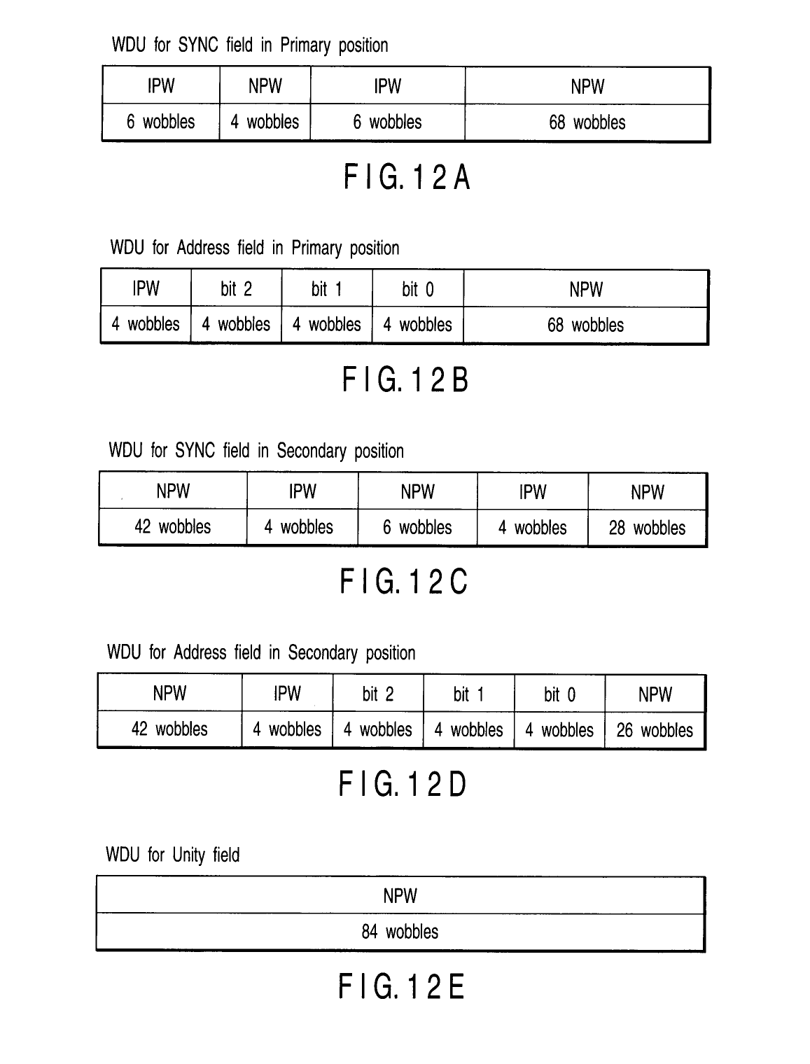

As shown in FIG. 11B, the address field contains identification code information (P,S), layer information, physical segment number, data segment address, and CRC. The wobble data unit WDU is made up of 84 wobble waves, and there are five types of WDUs, as shown in FIGS. 12A to 12E. The SYNC field and address field each have two types of WDUs, i.e., they have a total of four WDUs, and the unity field has one WDU.

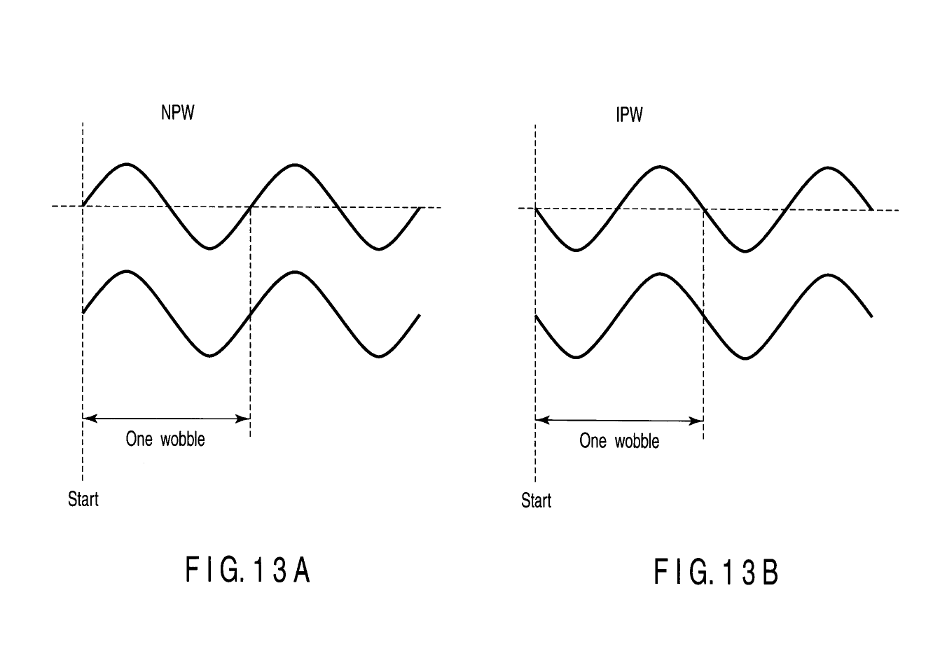

Three-bit data is embedded by wobble in the WDU of the address field. As shown in FIGS. 13A and 13B, data 0 and data 1 respectively correspond to an NPW (Normal Phase Wobble) and IPW (Inverted Phase Wobble).

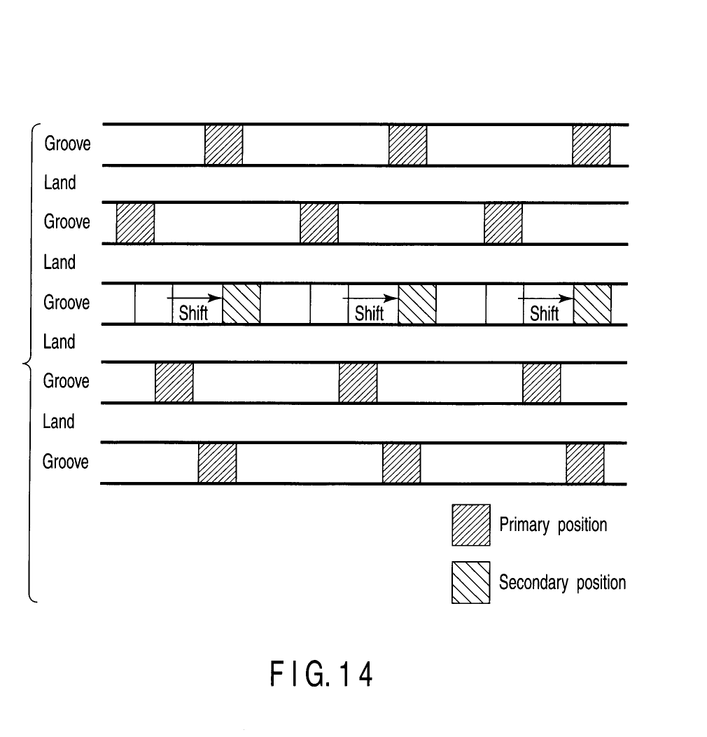

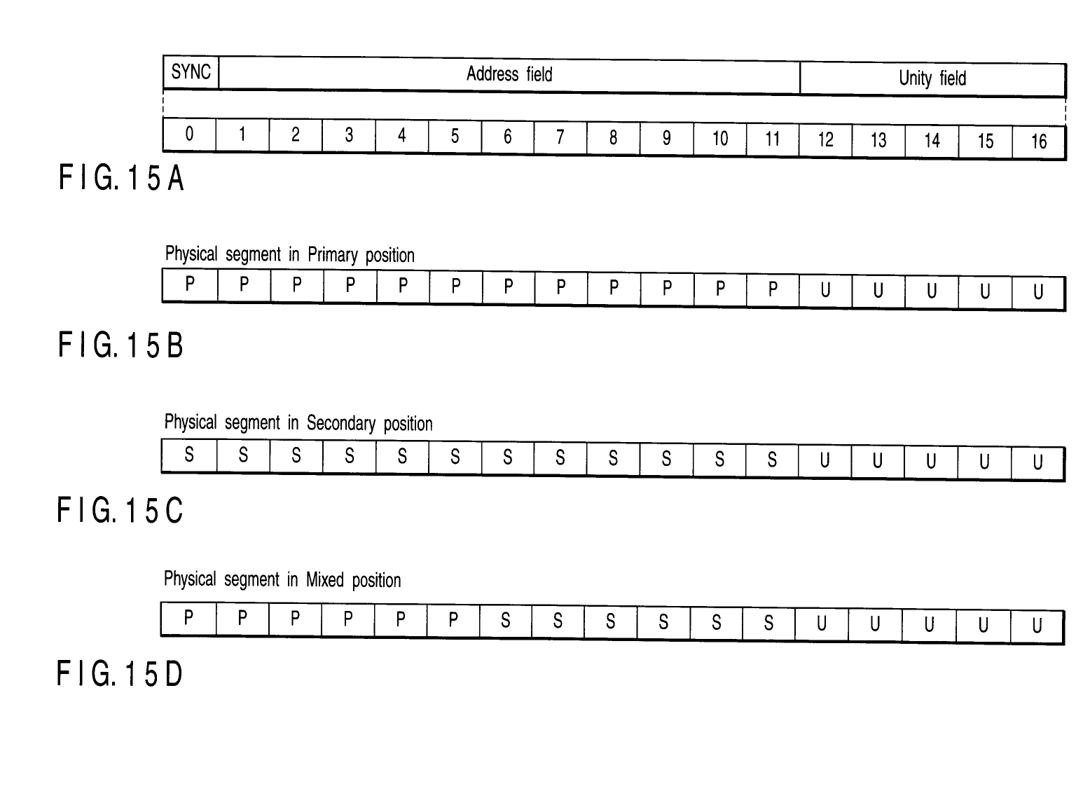

As shown in FIG. 14, the wobble data bit portions are shifted so that they do not appear in the same phase positions of adjacent grooves. For this purpose, the address field has two types of WDUs, i.e., a primary position and secondary position, and the SYNC field also has two types of WDUs accordingly. Consequently, the physical segment has a total of three types of configurations as shown in FIGS. 15B to 15D.

The address data format as described above is particularly effective in a Low-to-High write once optical disk. This is so because a low reflectance of the original unrecorded state prevents easy occurrence of interference of wobble phase information between adjacent grooves. Although a certain error rate can be obtained without switching the primary and secondary positions, the switching further improves the error rate.

Subsequently, a disk stamper 19 in which the wobble amplitude of the groove track Gt was changed from 3 to 28 nm was formed, and a write once information recording medium 28 using the dye J was formed by using the disk stamper 19. Evaluation tests were conducted by performing recording and playback on the groove track Gt.

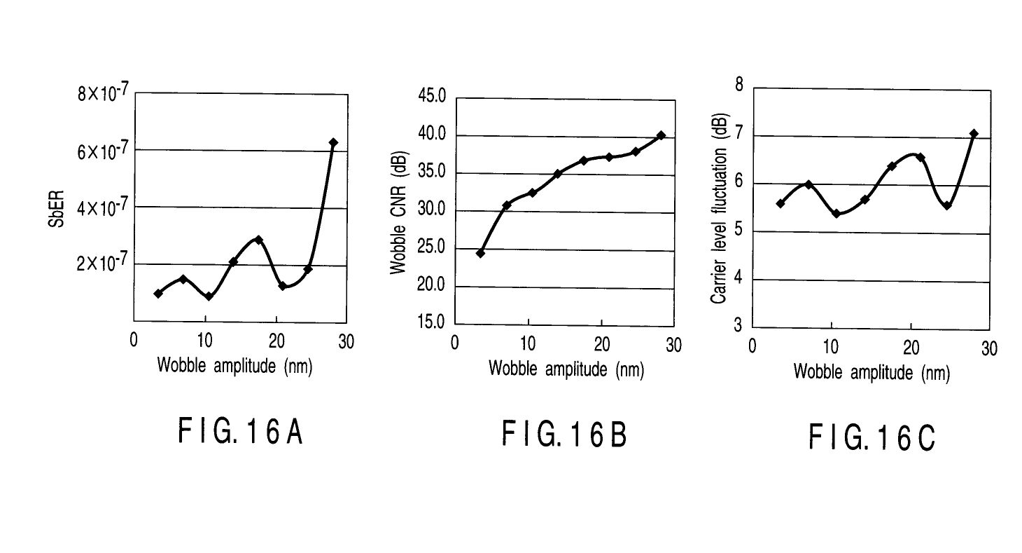

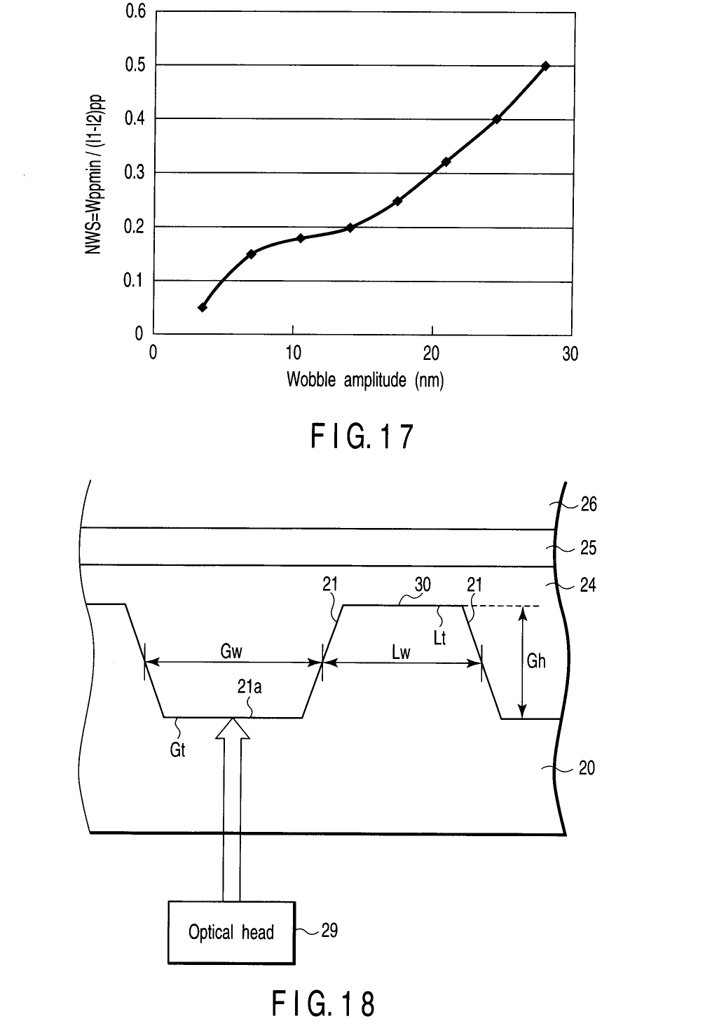

The measured evaluation characteristics were four characteristics: the SbER, a wobble CNR, a carrier level fluctuation as a signal beat fluctuation caused by a wobble signal on an adjacent track, and the NWS. FIG. 16A shows the measurement result of the SbER as a function of the wobble amplitude. FIG. 16B shows the measurement result of the wobble CNR as a function of the wobble amplitude. FIG. 16C shows the measurement result of the carrier level fluctuation as a function of the wobble amplitude. FIG. 17 shows the measurement result of the NWS as a function of the wobble amplitude.

The SbER is preferably as low as possible, the wobble CNR needs to be 26 dB or more, and the NWS can be 0.10 or more. The NWS can also be 0.10 to 0.45. When these conditions are applied to FIGS. 16A to 17, therefore, the wobble amplitude can be, e.g., 5 nm or more. Good characteristics can be obtained by setting the wobble amplitude within the range of 5 to 25 nm.

The wobble amplitude is optimally 5 to 18 nm within the above wobble amplitude range when the NWS is particularly preferably 0.10 to 0.25.

Note that FIGS. 16A to 17 show the characteristics of the write once information recording medium 28 using the dye J when the wobble amplitude was changed. The SbER, wobble CNR, carrier level fluctuation, and NWS of write once information recording media 28 using the dyes D, F, G, H, I, K, and L were also measured while the wobble amplitude was changed. Consequently, favorable results were obtained by any of these media when the wobble amplitude was 5 nm or more.

It was possible to greatly improve the PRSNR, SbER, wobble crosstalk, radial deviation, and the like by setting the recording film thickness to 50 to 120 nm on the groove and 20 to 70 nm on the land. It was also possible to effectively improve particularly the wobble NBSNR, and prevent easy occurrence of interference with wobble phase information between adjacent grooves. Good results were also obtained by setting the recording film thickness to 1.3 to 3 nm on the groove and/or land. It was further effective to set the groove width to 220 to 270 nm, and the groove depth to 50 to 80 nm.

As shown in FIG. 18, a recording/playback laser beam emitted from the optical head 29 enters a write once information recording medium 28 of the present invention from the surface opposite to the surface coated with a recording film 24 of a disk substrate 20.

A bottom surface 21a of a groove 21 formed in the disk substrate 20 and a land 30 sandwiched between adjacent grooves 21 are information recording tracks. A recording track formed by the bottom surface 21a of the groove 21 will be referred to as a groove track Gt thereinafter. A recording track formed by the land 30 will be referred to as a land track Lt hereinafter.

Also, the difference of the surface height of the groove track Gt from that of the land track Lt will be referred to as the groove depth Gh hereinafter. Furthermore, the width of the groove track Gt at a substantially ½ height of the groove depth Gh will be referred to as a groove width Gw, and the width of the land track Lt at a substantially ½ height of the groove depth Gh will be referred to as a land width Lw hereinafter.

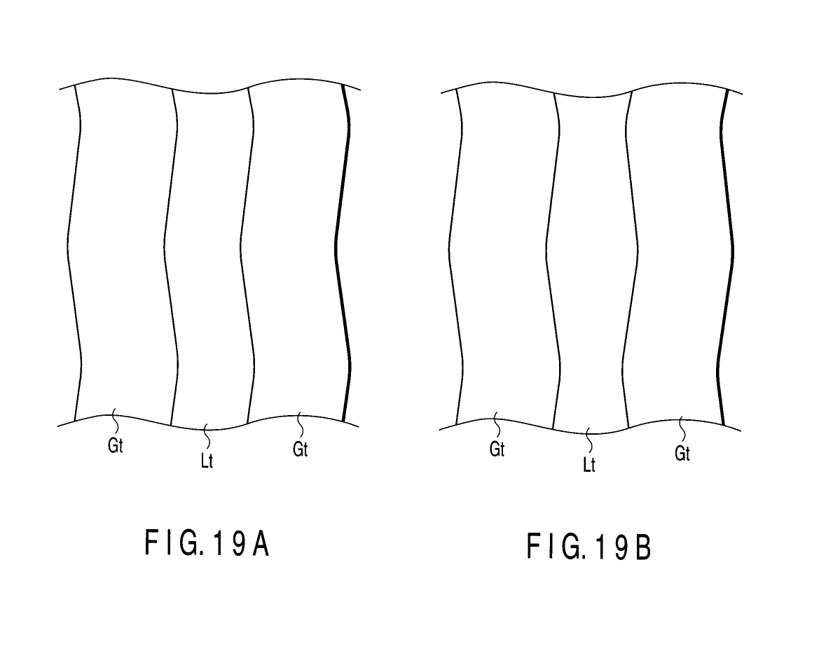

As described previously, the groove track Gt is wobbled to record various pieces of address information. FIG. 19A shows a case in which adjacent groove tracks Gt have the same phase. FIG. 19B shows a case in which adjacent groove tracks Gt have opposite phases. Adjacent groove tracks Gt have various phase differences depending on the region of the write once information recording medium 28.

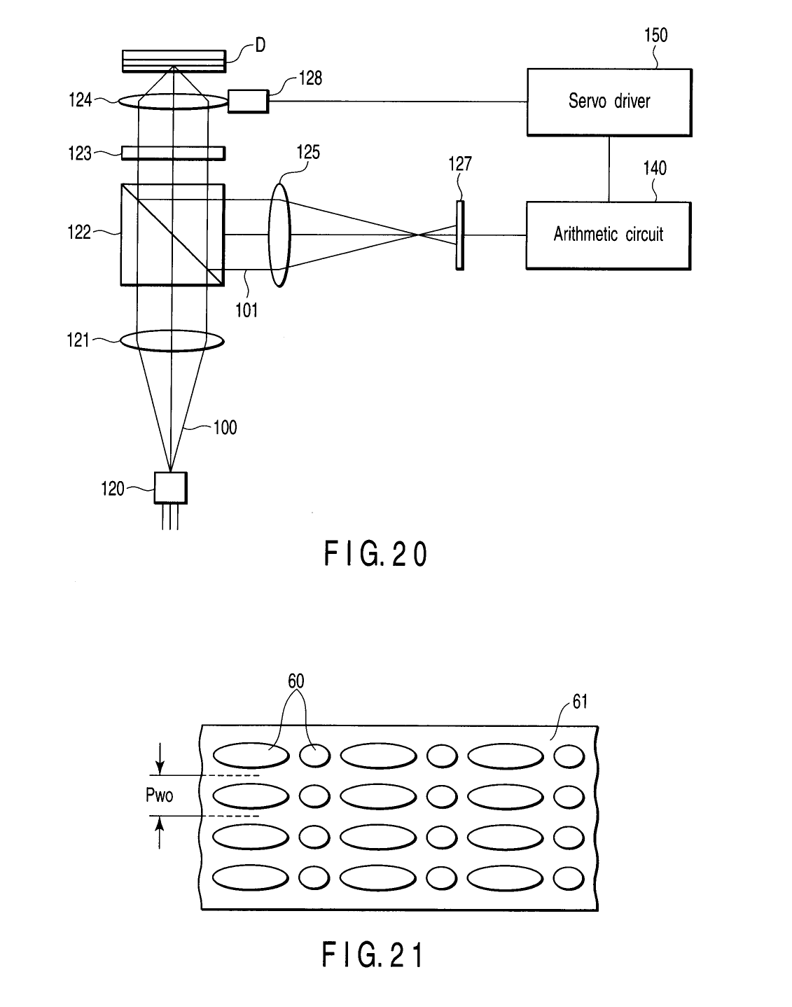

FIG. 20 is a block diagram showing an outline of the arrangement of a disk apparatus for playing back the write once information recording medium described above.

As shown in FIG. 20, a write once information recording medium D is, e.g., the single-sided, double-layer write once information recording medium shown in FIG. 1. A short-wavelength semiconductor laser source 120 is used as the light source. The wavelength of the emitted beam has a violet wavelength band of, e.g., 400 to 410 nm. An emitted beam 100 from the semiconductor laser source 120 is collimated into a parallel beam by a collimating lens 121, and enters an objective lens 124 through a polarizing beam splitter 122 and λ/4 plate 123. After that, the emitted beam 100 is concentrated on each information recording layer through the substrate of the write once information recording medium D. Reflected light 101 from the information recording layer of the write once information recording medium D is transmitted through the substrate of the write once information recording medium D again, and reflected by the polarizing beam splitter 122 through the objective lens 124 and λ/4 plate 123. After that, the reflected light 101 enters a photodetector 127 through a condenser lens 125.

A light-receiving part of the photodetector 127 is normally divided into a plurality of portions, and each light-receiving portion outputs an electric current corresponding to the light intensity. A 1/V amplifier (current-to-voltage converter) (not shown) converts the output electric current into a voltage, and applies the voltage to an arithmetic circuit 140. The arithmetic circuit 140 calculates, e.g., a tilt error signal, HF signal, focusing error signal, and tracking error signal from the input voltage signal. The tilt error signal is used to perform tilt control, the HF signal is used to play back information recorded on the write once information recording medium D, the focusing error signal is used to perform focusing control, and the tracking error signal is used to perform tracking control.

An actuator 128 can drive the objective lens 124 in the vertical direction, disk radial direction, and tilt direction (the radial direction and/or tangential direction). A servo driver 150 controls the actuator 128 so that the objective lens 124 follows an information track on the write once information recording medium D. Note that there are two types of tilt directions: “a radial tilt” which occurs when the disk surface inclines toward the center of the write once optical disk; and “a tangential tilt” which occurs in the tangential direction of a track. A tilt which generally occurs owing to the warpage of a disk is the radial tilt. It is necessary to take account of not only a tilt which occurs during the manufacture of a disk but also a tilt which occurs owing to a change with time or a rapid change in use environment.

### EXAMPLES

The present invention will be described in more detail below by way of its examples.

A double-layer HD DVD-R disk was manufactured as a sample of the write once information recording medium according to the present invention.

(Preparation of L0 Stamper)

Fourteen glass disks 200 mm in diameter and 6 mm in thickness precisely polished to have a surface roughness Ra of 0.3 nm were prepared.

Each glass disk was cleaned in the order of inorganic alkali solution cleaning, ultrapure water cleaning, electrolytic degreasing, hot water cleaning, and pull-up drying by using a cleaning apparatus manufactured by TECHNO OKABAYASHI.

Then, the surface of the glass disk was spin-coated with HMDS (hexamethyldisilazane) by using a resist coating apparatus (manufactured by Access), and further spin-coated with a photoresist (DVR300 manufactured by ZEON). After that, the glass disk was prebaked on a hot plate (100° C., 10 min).

An HD DVD-R L0 signal corresponding to a concentric or spiral pattern was recorded on the 14 resist-coated glass disks by using a UV laser cutting machine (LBR manufactured by Matsushita Electric), while the pit width of each glass disk was changed every 10 nm from 200 to 320 nm. The UV laser was a krypton ion laser having a wavelength of 351 nm, and the objective lens was an NA-0.90 type lens manufactured by Corning Toropel. The HD DVD-R signal source used was an HD DVD-R formatter manufactured by KENWOOD TMI.

Then, the recorded resist disks were spin-developed by a developing apparatus (manufactured by Access). The developer used was a dilute inorganic alkali developer prepared by mixing ultrapure water in an inorganic alkali developer (DE3 manufactured by TOKYO OHKA KOGYO) at a mixing ratio of 2:1.

Subsequently, an Ni sputtering apparatus (manufactured by Victor Company of Japan) was used to sputter a thin Ni film on each developed disk to make it conductive. The Ni film thickness was 10 nm. After that, Ni electroforming was performed in a nickel sulfamate solution hot bath by using an electroforming apparatus (manufactured by NOVEL), thereby removing the Ni film from the resist disk. The duplicated Ni stamper was then spin-cleaned and ashed with oxygen by an RIE apparatus to remove the residual photoresist from the surface, thereby forming, e.g., projecting read-only recording mark patterns.

After that, the Ni stamper surface was spin-coated with a protective film (CLEANCOAT S manufactured by FINE CHEMICAL JAPAN), and an L0 stamper was completed by polishing the back surface, and punching the inner and outer diameters.

(Preparation of L1 Mother Stamper)

Fourteen glass disks 200 mm in diameter and 6 mm in thickness precisely polished to have a surface roughness Ra of 0.3 nm were prepared and cleaned in the order of inorganic alkali solution cleaning, ultrapure water cleaning, electrolytic degreasing, hot water cleaning, and pull-up drying by using the cleaning apparatus manufactured by TECHNO OKABAYASHI.

Then, the surface of each glass disk was spin-coated with HMDS (hexamethyldisilazane) by using the resist coating apparatus (manufactured by Access), and further spin-coated with the photoresist (DVR300 manufactured by ZEON). After that, the glass disk was prebaked on the hot plate (100° C., 10 min).

An HD DVD-R L1 signal corresponding to a concentric or spiral pattern was recorded on these resist-coated glass disks by using the UV laser cutting machine (LBR manufactured by Matsushita Electric). In addition, read-only recording mark patterns were formed into a predetermined array by increasing the recording laser output, while the pit width was made larger than that of the read-only recording mark patterns of the L0 mother pattern and changed every 10 nm from 240 to 370 nm. The UV laser was a krypton ion laser having a wavelength of 351 nm, and the objective lens was the NA-0.90 type lens manufactured by Corning Toropel. The HD DVD-R signal source used was the HD DVD-R formatter manufactured by KENWOOD TMI.

Then, the recorded resist disks were spin-developed by the developing apparatus (manufactured by Access). The developer used was the dilute inorganic alkali developer prepared by mixing ultrapure water in the inorganic alkali developer (DE3 manufactured by TOKYO OHKA KOGYO) at a mixing ratio of 2:1.

Subsequently, the Ni sputtering apparatus (manufactured by Victor Company of Japan) was used to sputter a thin Ni film on each developed disk to make it conductive. The Ni film thickness was 10 nm. After that, Ni electroforming was performed in the nickel sulfamate solution hot bath by using the electroforming apparatus (manufactured by NOVEL), thereby removing the Ni film from the resist disk. The duplicated Ni father stamper was spin-cleaned and ashed with oxygen by an RIE apparatus to remove the residual photoresist from the surface, thereby forming land and groove patterns. In addition, projecting read-only recording mark patterns, for example, were formed on portions of the land and groove patterns in the same manner as for the L0 stamper except that the pit width was changed every 10 nm from 240 to 370 nm. This RIE step was also a passivation process. After that, the electroforming apparatus was used again to electroform the Ni father stamper in the nickel sulfamate bath to duplicate an Ni mother stamper having, e.g., recessed read-only recording mark patterns on portions of the land and groove patterns. The surface of this Ni mother stamper was spin-coated with the protective film (CLEANCOAT S manufactured by FINE CHEMICAL JAPAN), and an L1 mother stamper was obtained by polishing the back surface, and punching the inner and outer diameters.

(Duplication of Double-Layer HD DVD-R Disk)

A disk was manufactured using a double-layer HD DVD-R mass-production manufacturing line facility manufactured by Origin Electric. The process procedure was as follows.

The L0 stamper was attached to the SD40E injection compression molding apparatus manufactured by Sumitomo Heavy Industries, thereby molding a polycarbonate disk substrate. Portions of the land and groove tracks of the obtained polycarbonate disk substrate had, e.g., the recessed read-only recording marks.

FIG. 21 is a model view showing an example of the array of the read-only recording marks formed on the land and groove tracks.

As shown in FIG. 21, read-only recording marks 60 had a predetermined pit width Pw0 and were formed into a predetermined array on land and groove track patterns 61. The polycarbonate resin was AD5503 manufactured by TEIJIN CHEMICALS. The mold was the G mold manufactured by SEIKOH GIKEN. The mold shrinkage factor was 0.6%. The molded plate thickness was 590 μm.

The L1 mother stamper was attached to another injection compression molding apparatus (SD40E manufactured by Sumitomo Heavy Industries), thereby molding a polycarbonate disk substrate. Portions of the land and groove tracks of the obtained polycarbonate disk substrate had the projecting read-only recording marks having a pit width Pw1 larger by 40 nm than the predetermined pit width Pw0. The polycarbonate resin was AD5503 manufactured by TEIJIN CHEMICALS. The mold was the G mold manufactured by SEIKOH GIKEN. The mold shrinkage factor was 0.6%. The molded plate thickness was 590 μm.

After the L0 molded disk substrate was cooled, an L0 organic dye solution was applied by spin coating and dried, and an AgBi (Bi: 0.3% to 1%) film was DC-sputtered (the sputtering apparatus was an HD DVD-R double-layer Ag alloy film formation apparatus manufactured by Unaxis). The thickness of the AgBi film was 20 nm. After that, an ultraviolet-curing resin was applied by spin coating, adhered to the L1 molded disk substrate, and cured by ultraviolet radiation. The thickness of the ultraviolet-curing resin layer was 28 μm. When the L1 molded disk substrate was removed after that, a transfer pattern of the L1 molded substrate was transferred to the surface of the ultraviolet-curing resin on the L0 substrate. This pattern was an L1 pattern. The L1 read-only recording marks each had the predetermined pit width Pw1 larger by, e.g., 40 nm than the pit width Pw0 of the L0 read-only recording marks, and were formed to have, e.g., a recessed shape into a predetermined array in accordance with the groove track patterns.

Then, an L1 organic dye solution was applied by spin coating and dried, and an AgBi (Bi: 0.3% to 1%) film was DC-sputtered (the sputtering apparatus was the HD DVD-R double-layer Ag alloy film formation apparatus manufactured by Unaxis). The thickness of the AgBi film was 100 nm. Then, a UV adhesive (6810 manufactured by DAINIPPON INK AND CHEMICALS) was applied by spin coating, adhered to the L1 molded substrate already used and removed, and cured by ultraviolet radiation. After that, a label was printed by a label printer.

Thus, a double-layer HD DVD-R disk was manufactured.

The L0 dye used was prepared by mixing the dyes D5 and D6 at a ratio of 9:1, and the L1 dye was prepared by mixing the dyes D2 and D3 at a ratio of 1:1.

The organic dye solution used was prepared by dissolving 1.2 g (wt %) of an organic dye powder in 100 mL of TFP, and hence had a solution concentration of 1.2%. This organic dye solution can be easily prepared by putting the dye powder in the solvent and applying ultrasonic waves for 30 min.

The Low-to-High recording disk according to the present invention can achieve favorable effects when inserting management information (system lead-in) into a certain portion of the disk, e.g., the innermost region.

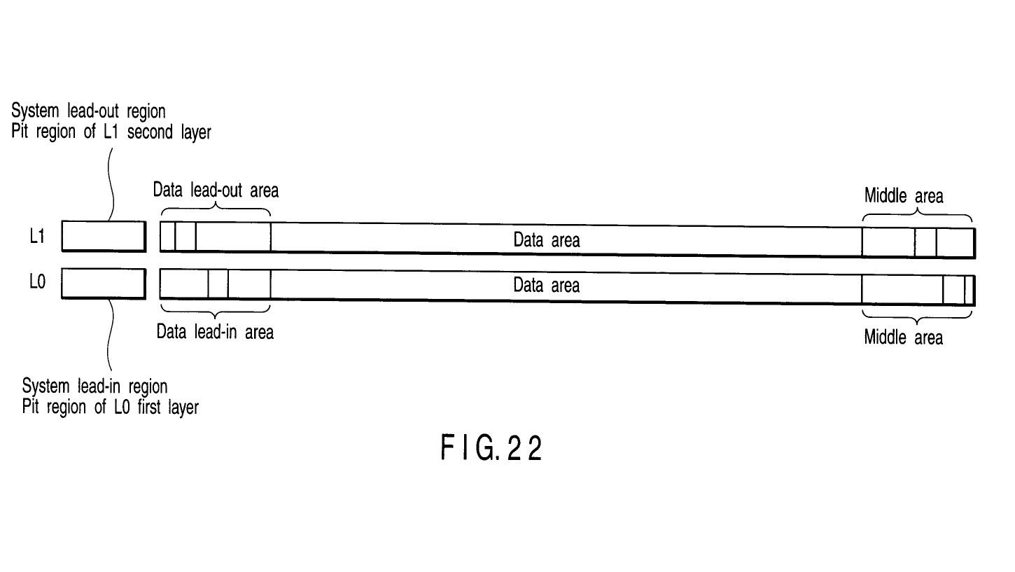

FIG. 22 is a view for explaining an example of the data structure of the double-layer HD DVD-R disk according to the present invention.

Referring to FIG. 22, the left side indicates the inside of the disk, and the right side indicates the outside of the disk.

As shown in FIG. 22, management information forms pit strings similar to those of a ROM disk substrate on the disk substrate. For example, management information indicating whether the disk is a read-only disk, write once disk, or rewritable disk, the recording/playback wavelength of the disk, whether the disk is a Low-to-High disk or High-to-Low disk, the recording data capacity of the disk, and the like is recorded as pit strings. Although the track pitch of the groove in the recording data area is 400 nm or 320 to 300 nm, the track pitch of the pit strings in this management information area is larger than that, and the data bit pitch of the pit is also larger than that in the recording data area. This facilitates playback and discrimination of the management information.

Tables below show the results of the playback signal characteristics of a system lead-in area (L0) and system lead-out area (L1) in a read-only area. The ODU1000 information recording medium evaluation apparatus manufactured by Pulstec was used to measure the jitter, modulation degree, symmetry, and reflectance of each of the first recording film (L0) and second recording film (L1) of a prototype double-layer HD DVD-R disk formed by using the stampers in which the pit width was changed as described above.

The testing conditions were that the objective lens numerical aperture NA of the optical head 29 was 0.65, the wavelength of the recording/playback laser beam was 405 nm, and the recording/playback linear velocity was 6.61 m/sec. A recording signal was random data having undergone 8-12 modulation, and had a waveform to be recorded by a constant recording power and two types of bias powers 1 and 2 as shown in FIG. 8.

The track pitch was 400 nm, the groove width Gw was “1.1” with respect to “1” as the land width Lw, the wobble amplitude of the groove track Gt was 14 nm, and the groove depth Gh was 90 nm. Note that wobble recording of address information was done by using wobble phase modulation.

Table 6 shows the results obtained by the first recording film (L0). Table 7 shows the results obtained by the second recording film (L1).

TABLE 6

| | Pit width | | Modulation | | Reflectance |
|---|---|---|---|---|---|
| Sample | (nm) | Jitter (%) | degree | Symmetry | (%) |
| 1 | 200 | 5.2 | 0.71 | −0.15 | 4 |
| 2 | 210 | 5.1 | 0.72 | −0.12 | 4.1 |
| 3 | 220 | 4.9 | 0.72 | −0.09 | 4.21 |
| 4 | 230 | 4.8 | 0.73 | −0.08 | 4.32 |
| 5 | 240 | 4.6 | 0.73 | −0.07 | 4.47 |
| 6 | 250 | 4.4 | 0.73 | −0.04 | 4.51 |
| 7 | 260 | 4.3 | 0.75 | −0.01 | 4.60 |
| 8 | 280 | 4.1 | 0.74 | 0.00 | 4.68 |
| 9 | 290 | 4.6 | 0.73 | 0.01 | 4.72 |
| 10 | 300 | 4.4 | 0.73 | 0.02 | 4.81 |
| 11 | 310 | 4.6 | 0.75 | 0.03 | 4.92 |
| 12 | 320 | 5.3 | 0.74 | 0.05 | 5.10 |
| 13 | 310 | 5.6 | 0.75 | 0.03 | 5.15 |
| 14 | 320 | 6.1 | 0.74 | 0.05 | 5.30 |

TABLE 7

| | Pit width | | Modulation | | Reflectance |
|---|---|---|---|---|---|
| Sample | (nm) | Jitter (%) | degree | Symmetry | (%) |
| 1 | 370 | 3.8 | 0.75 | 0.05 | 5.10 |
| 2 | 360 | 4 | 0.73 | 0.02 | 4.88 |
| 3 | 350 | 4.2 | 0.72 | 0 | 4.61 |
| 4 | 340 | 4.3 | 0.72 | −0.01 | 4.35 |
| 5 | 330 | 4.5 | 0.72 | −0.02 | 4.23 |
| 6 | 320 | 5 | 0.71 | −0.03 | 4.12 |
| 7 | 310 | 5.4 | 0.7 | −0.04 | 3.92 |
| 8 | 300 | 5.8 | 0.68 | −0.05 | 3.55 |
| 9 | 290 | 6 | 0.67 | −0.05 | 3.21 |
| 10 | 280 | 6.2 | 0.65 | −0.06 | 3.06 |
| 11 | 270 | 6.4 | 0.64 | −0.07 | 3.01 |
| 12 | 260 | 6.6 | 0.62 | −0.08 | 2.97 |
| 13 | 250 | 6.9 | 0.61 | −0.09 | 2.94 |
| 14 | 240 | 7.4 | 0.59 | −0.10 | 2.93 |

As shown in Tables 6 and 7, satisfactory characteristics were obtained when the pit width of the second read-only recording mark was larger than that of the first read-only recording mark. Also, satisfactory characteristics were obtained when the reflectances of the pits of the first and second read-only recording marks were 4.2% to 8.4%.

In particular, the disk pit width could be 250 nm or more in L0. Furthermore, good characteristics were obtained when this pit width was 260 to 310 nm.

On the other hand, as shown in Table 7, the disk pit width could be 330 nm or more in L1. Also, good characteristics were obtained when this pit width was 330 to 360 nm.

For comparison, the jitter, modulation degree, symmetry, and reflectance were similarly measured by making the pit width of the second read-only recording mark smaller than that of the first read-only recording mark, e.g., by setting the former pit width to 240 nm. Consequently, the jitter, modulation degree, symmetry, and reflectance were respectively 7.4%, 0.59, −0.10, and 2.93%, i.e., the results were more or less worse. Also, when the pit reflectances were set out of the range of 4.2% to 8.4%, e.g., when the L0 reflectance was set at 3.9% and the L1 reflectance was set at 8.6%, the focusing servo became unstable to make layer selection difficult, and this made it impossible to read out information from the system lead-in and system lead-out.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A write once information recording medium comprising:
a transparent resin substrate having a groove and land with one of a concentric shape and a spiral shape;
a first recording film formed on the groove and land of the transparent resin substrate;
an interlayer formed on the first recording film and made of a transparent resin material having a groove and land with said one of the concentric shape and the spiral shape; and
a second recording film formed on the groove and land of the interlayer,
wherein a recording mark is formed by irradiation with a short-wavelength laser beam, and a light reflectance of the recording mark formed by irradiation with the short-wavelength laser beam is higher than a light reflectance before irradiation with the short-wavelength laser beam,
the groove wobbles within a predetermined amplitude range,
the first recording film has a first read-only recording mark recorded by a three-dimensional pit,
the second recording film has a second read-only recording mark recorded by a three-dimensional pit, and
a reflectance of the first read-only recording mark and a reflectance of the second read-only recording mark are 4.2% to 8.4%.

2. A medium according to claim 1, wherein the reflectance of the first read-only recording mark is higher than the reflectance of the second read-only recording mark.

3. A medium according to claim 1, wherein a pit width of the second read-only recording mark is larger than a pit width of the first read-only recording mark.

4. A medium according to claim 3, wherein the pit width of the first read-only recording mark is 250 to 320 nm, and the pit width of the second read-only recording mark is 330 nm to 360 nm.

5. A write once information recording medium comprising:
a transparent resin substrate having a groove and land with one of a concentric shape and a spiral shape;
a first recording film formed on the groove and land of the transparent resin substrate;
an interlayer formed on the first recording film and made of a transparent resin material having a groove and land with said one of the concentric shape and the spiral shape; and
a second recording film formed on the groove and land of the interlayer,
wherein a recording mark is formed by irradiation with a short-wavelength laser beam, and a light reflectance of the recording mark formed by irradiation with the short-wavelength laser beam is higher than a light reflectance before irradiation with the short-wavelength laser beam,
the groove wobbles within a predetermined amplitude range,
the first recording film has a first read-only recording mark recorded by a three-dimensional pit,
the second recording film has a second read-only recording mark recorded by a three-dimensional pit, and
a pit width of the second read-only recording mark is larger than a pit width of the first read-only recording mark.

6. A medium according to claim 5, wherein the pit width of the first read-only recording mark is 250 to 320 nm, and the pit width of the second read-only recording mark is 330 nm to 360 nm.

7. A disk apparatus for playing back a write once information recording medium comprising a transparent resin substrate having a groove and land with one of a concentric shape and a spiral shape, a first recording film formed on the groove and land of the transparent resin substrate, an interlayer formed on the first recording film and made of a transparent resin material having a groove and land with said one of the concentric shape and the spiral shape, and a second recording film formed on the groove and land of the interlayer,
wherein a recording mark is formed by irradiation with a short-wavelength laser beam, and a light reflectance of the recording mark formed by irradiation with the short-wavelength laser beam is higher than a light reflectance before irradiation with the short-wavelength laser beam,
the groove wobbles within a predetermined amplitude range,
the first recording film has a first read-only recording mark recorded by a three-dimensional pit,
the second recording film has a second read-only recording mark recorded by a three-dimensional pit, and
a reflectance of the first read-only recording mark and a reflectance of the second read-only recording mark are 4.2% to 8.4%.

8. An apparatus according to claim 7, wherein the reflectance of the first read-only recording mark is higher than the reflectance of the second read-only recording mark.

9. An apparatus according to claim 7, wherein a pit width of the second read-only recording mark is larger than a pit width of the first read-only recording mark.

10. A medium according to claim 9, wherein the pit width of the first read-only recording mark is 250 to 320 nm, and the pit width of the second read-only recording mark is 330 nm to 360 nm.

11. A disk apparatus for playing back a write once information recording medium comprising a transparent resin substrate having a groove and land with one of a concentric shape and a spiral shape, a first recording film formed on the groove and land of the transparent resin substrate, an interlayer formed on the first recording film and made of a transparent resin material having a groove and land with said one of the concentric shape and the spiral shape, and a second recording film formed on the groove and land of the interlayer,
wherein a recording mark is formed by irradiation with a short-wavelength laser beam, and a light reflectance of the recording mark formed by irradiation with the short-wavelength laser beam is higher than a light reflectance before irradiation with the short-wavelength laser beam,
the groove wobbles within a predetermined amplitude range,
the first recording film has a first read-only recording mark recorded by a three-dimensional pit,
the second recording film has a second read-only recording mark recorded by a three-dimensional pit, and
a pit width of the second read-only recording mark is larger than a pit width of the first read-only recording mark.

12. An apparatus according to claim 11, wherein pit width of the first read-only recording mark is to 320 nm, and the pit width of the second read-recording mark is 330 nm to 360 nm.
